(19) United States
(12) Patent Application Publication
(10) Pub. No.: US 2009/0035505 A1
(43) Pub. Date: Feb. 5, 2009

(54) OPTICAL INFORMATION RECORDING MEDIUM AND METAL COMPLEX

(75) Inventors: Kousuke Watanabe, Kanagawa (JP); Chisato Obara, Kanagawa (JP); Kazutoshi Katayama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku , Tokyo (JP)

(21) Appl. No.: 12/279,228

(22) PCT Filed: Feb. 27, 2007
(86) PCT No.: PCT/JP2007/054136

§ 371 Date: Aug. 13, 2008

(30) Foreign Application Priority Data
Feb. 28, 2006 (JP) 2006-053819

(51) Int. Cl. B32B 3/02; C07F 3/06; C07F 15/04; C07F 1/08

(52) U.S. Cl. 428/64.4; 544/226; 544/225; 549/3; 548/107

(57) ABSTRACT

The invention provides an optical information recording medium having at least a substrate and a recording layer capable of recording information provided on the substrate. The recording layer contains at least a metal complex compound obtained by forming a salt from a cationic part and an anionic part, and the cationic part being a cation of a metal complex having a molar absorbance coefficient (∈) in the wavelength range of 350 to 1300 nm of 10,000 dm³ mol⁻¹ cm⁻¹ or less when an anionic part is any one of Cl⁻, Br⁻, I⁻, ClO₄⁻, PF₆⁻, BF₄⁻, SO₄²⁻, or CF₃SO₃⁻. A thermal decomposition temperature of the metal complex is preferably 250° C. or higher when an anionic part of any one of Cl⁻, Br⁻, I⁻, ClO₄⁻, PF₆⁻, BF₄⁻, SO₄²⁻, or CF₃SO₃⁻.

### BACKGROUND

1. Technical Field

The invention relates to a metal complex compound and an optical information recording medium which is capable of recording and reproducing information using a laser beam. Specifically, the invention relates to a metal complex compound with less coloration and a heat mode optical information recording medium that is suitable for recording and reproducing information using a short wavelength laser beam having a wavelength of 400 to 410 nm.

2. Related Art

Optical recording media (optical discs) where information is recorded only once by laser beam irradiation are known. Such optical discs, often called recordable CD's (so-called CD-R), have a typical structure wherein a recording layer containing an organic dye, a light reflection layer of a metal such as gold, and a resin protective layer are formed on a transparent disk-shaped substrate in that order. Information is recorded on a CD-R by irradiation of a laser beam in the near-infrared region onto the CD-R (normally, laser beam at a wavelength of around 780 nm). In the irradiated area of the recording layer light is absorbed, there is a resulting localized increase in temperature, and this changes its physical and chemical properties (e.g., pit generation). Because of these physical and chemical changes the optical properties are changed and information can be recorded. Reading of the information (reproduction) is also carried out by irradiating with a laser beam having a wavelength the same as that of the recording laser beam. Information is reproduced by detecting the difference in reflectance between areas where the optical properties of the recording layer have been changed (recorded area) and areas where they are not changed (unrecorded area).

Recently, networks such as Internet and high-definition TV's are rapidly becoming more and more popular. HDTV (High-Definition Television) broadcasting has also resulted in increased need for a large-capacity recording medium for recording image information more cost-effectively. The CD-R's described above, and write-once digital-versatile-disks (so-called DVD-R's) allowing high-density recording by using a visible laser beam (630 to 680 nm), have established themselves as large-capacity recording media to some extent, but still, do not have a recording capacity large enough to cope with future requirement. Optical disks having higher recording density and larger recording capacity, and that use a laser beam having a wavelength shorter than that for DVD-R's have been studied, and, for example, a photorecording disk in the so-called “Blu-ray mode” that uses a blue laser having a wavelength of 405 nm has been commercialized.

Conventionally, a dye compound having absorption in the near infrared range, such as a dicarbocyanine dye (having five methine chains) or a tricarbocyanine dye (having seven methine chains), each of which has a benzindolenine backbone, has been advantageously used as a dye compound included in a recording layer of a CD-R type optical disk (for example, refer to Japanese Patent Application Laid-Open (JP-A) Nos. 64-40382 and 64-40387).

Besides the above-described compound, a compound having a diimmonium salt as a counter cation of an oxonol dye (for example, refer to U.S. Pat. No. 6,713,147) and a compound in which a metal complex with a large molar absorbance coefficient is provided so as to form a cationic part of an oxonol dye (for example, refer to JP-A No. 2002-52825) have been known as a dye compound.

Dye compounds such as cyanine dye compounds and oxonol dye compounds are generally easily discolored by being exposed to light. In order to improve their light resistance, techniques including utilization of a combination of a singlet oxygen quencher as a discoloration inhibitor, such as a nitroso compound, a nickel complex or the like, and a dye compound such as the above-described cyanine compounds and the like, have been disclosed. Techniques including utilization of organic oxidizing agents as counter salts for dyes are also known in the art (for example, refer to U.S. Pat. Nos. 5,318,882, 5,204,220 and 5,879,772).

However, because cyanine dyes and oxonol dyes generally have a low light resistance themselves and the recording characteristics thereof tend to easily deteriorate, when using cyanine dyes or oxonol dyes as a dye component in a recording layer, the light resistance of the dye component may be insufficient when the above conventional technologies alone are applied thereto, which may cause a problem that the recording-and-reproducing characteristic cannot be maintained. Further, there is a tendency for durability of an optical medium to decrease anyway with the use of a laser beam for recording and reproducing.

It is hoped that there will be a technique of improving the light resistance of dye components used in recording layers to record electronic information as a technology to increase the recording-and-reproducing characteristics when applied to an optical recording disk compatible with a blue laser beam, DVD-R, and CD-R.

Although cyanine dyes and oxonol dyes have been applied conventionally as useful dye components as described above, they have the problem of being inferior in the light resistance. Also, when metal complexes and singlet oxygen quenchers, which have been used for optical disks, are added at amounts necessary to improve the light resistance, there is also the countering problem that the recording characteristics may deteriorated.

### SUMMARY

The invention was made in consideration of the above problems. The invention provides an optical information recording medium which is superior in electronic information recording and reproducing characteristics and in light resistance, as well as in durability to the reproducing light when reproducing electronic information (specifically, the invention provides an optical information recording medium which is capable of recording and reproducing with a blue laser beam of 440 nm or less). In addition, the invention provides a metal complex compound with less coloration (for example, less of the type of coloration which impairs the recording and reproducing characteristics when used as a dye component of a recording layer recording and reproducing electronic information in an optical information recording medium) and superior in light resistance (for example, including resistance to reproducing light used in an optical information recording medium).

The invention is achieved based on the knowledge obtained by the inventors that in the case where a molar absorbance coefficient (∈) of a metal complex cation of a metal complex compound is small, in the case where a specific metal complex compound is combined with a specific oxonol dye, or in the case where a metal complex compound in which a cationic part derived from a specific metal complex and an anionic part derived from a specific oxonol dye form a salt is used, the recording-and-reproducing characteristic of the electronic information is remarkably suppressed so as be effective to obtain the improvement in the light resistance. Namely, the invention is given as follows.

Namely, the first aspect of the invention provides an optical information recording medium comprising a substrate and a recording layer capable of recording information provided on the substrate, the recording layer comprising a metal complex compound obtained by forming a salt from a cationic part and an anionic part, and the cationic part being a cation of a metal complex having a molar absorbance coefficient (∈) in the wavelength range of 350 to 1300 nm of 10,000 dm³ mol⁻¹ cm⁻¹ or less when an anionic part is any one of Cl⁻, Br⁻, I⁻, ClO₄⁻, PF₆⁻, BF₄⁻, SO₄²⁻, or CF₃SO₃⁻.

The optical information recording medium of the first aspect of the invention is configured by a recording layer having a low absorbance to a laser beam having the wavelength around 400 nm, that is to say a recording layer having low coloration that affects the recording and reproducing of electronic information, by specifically providing a metal complex cation for which the molar absorbance coefficient (∈) is 10,000 dm³ mol⁻¹ cm⁻¹ or less in the wavelength range of 350 to 1300 nm as a cationic part of a metal complex compound. Consequently, the recording and reproducing characteristic of electronic information may be improved, and the optical information recording medium may be made superior in light resistance after recording as well as in the durability to reproducing light for reproduction. The optical information recording medium of the first aspect of the invention is specifically useful for recording and reproducing with a blue laser beam of 440 μm or less.

In one embodiment of the optical information recording medium of the first aspect of the invention, a thermal decomposition temperature of the metal complex is 250° C. or higher when an anionic part of any one of Cl⁻, Br⁻, I⁻, ClO₄⁻, PF₆⁻, BF₄⁻, SO₄²⁻, or CF₃SO₃⁻.

According to the above embodiment of the optical information recording medium, the recording-and-reproducing characteristic of the electronic information can be further improved.

In another embodiment of the optical information recording medium of the first aspect of the invention, the cationic part is represented by one of the following Formulae (1) or (2).

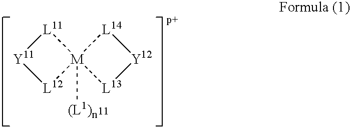

In Formula (1): M represents a metal atom; each of Y¹¹ and Y¹² independently represents a linking group, a single bond, or a double bond; each of L¹, L¹¹, L¹², L¹³, and L¹⁴ independently represents a ligand, and L¹¹ to L¹⁴ may be linked to each other through a linking group which is other than Y¹¹ and Y¹²; n¹¹ represents an integer of 0 to 2; and p represents an integer of 1 to 3.

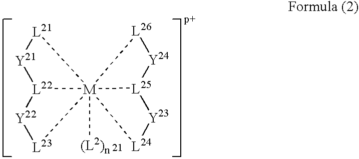

In Formula (2): M represents a metal atom; each of Y²¹, Y²², Y²³, and Y²⁴ independently represents a linking group, a single bond, or a double bond; each of L², L²¹, L²², L²³, L²⁴, L²⁵, and L²⁶ independently represents a ligand, and L²¹ to L²⁶ may be linked to each other through a linking group which is other than Y²¹ to Y²⁴; n²¹ represents an integer of 0 to 2; and p represents an integer of 1 to 3.

According to the above embodiment of the optical information recording medium, because the cationic part has the above-described structure, it has less absorbance at wavelengths of around 400 nm so as to be substantially colorless, so that the coloration that affects the recording and reproducing of electronic information can be suppressed. Accordingly, the embodiment is superior in recording and reproducing characteristic of electronic information and light resistance after recording, and the durability to reproducing light for reproduction is also improved. The expression “substantially colorless” used herein means that there is no coloration that affects the recording and reproducing of electronic information.

In another embodiment of the optical information recording medium of the first aspect of the invention, the cationic part is represented by one of the following Formulae (3) or (4).

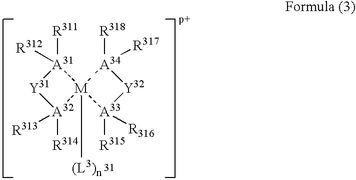

In Formula (3): M represents a metal atom; each of A³¹, A³², A³³, and A³⁴ independently represents a nitrogen atom or a phosphorus atom; each of Y³¹ and Y³² independently represents a linking group; each of R³¹¹, R³¹², R³¹³, R³¹⁴, R³¹⁵, R³¹⁶, R³¹⁷, and R³¹⁸ independently represents a hydrogen atom or a substituent, and R³¹¹ to R³¹⁸ may be linked to each other through a linking group which is other than Y³¹ and Y³²; L³ represents a ligand; n³¹ represents an integer of 0 to 2; and p represents an integer of 1 to 3.

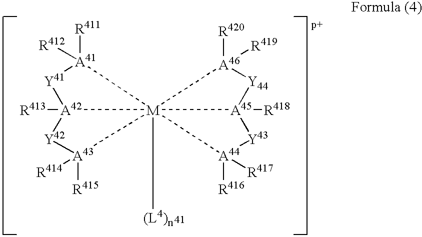

In Formula (4): M represents a metal atom; each of A⁴¹, A⁴², A⁴³, A⁴⁴, A⁴⁵, and A⁴⁶ independently represents a nitrogen atom or a phosphorus atom; each of Y⁴¹, Y⁴², Y⁴³, and Y⁴⁴ independently represents a linking group; each of R⁴¹¹, R⁴¹², R⁴¹³, R⁴¹⁴, R⁴¹⁵, R⁴¹⁶, R⁴¹⁷, R⁴¹⁸, R⁴¹⁹, and R⁴²⁰ independently represents a hydrogen atom or a substituent, and R⁴¹¹ to R⁴²⁰ may be linked to each other through a linking group which is other than Y⁴¹ to Y⁴⁴; L⁴ represents a ligand; n⁴¹ represents an integer of 0 to 2; and p represents an integer of 1 to 3.

According to the above embodiment of the optical information recording medium, because each of the coordination atoms represented by A³¹ to A³⁴ is a nitrogen atom or a phosphorus atom, the absorbance of light having a wavelength of around 400 nm, that is the coloration that affects the recording and reproducing, can be suppressed to be low. Therefore, it can be superior in the recording-and-reproducing characteristic of the electronic information and the light resistance after recording, and effective for the improvement of the durability to reproducing light at reproduction.

In another embodiment of the optical information recording medium of the first aspect of the invention, the cationic part is represented by Formula (3), each of the linking groups represented by Y³¹ or Y³² is an alkylene group or an arylene group, and the ligand represented by L³ is a hydrogen atom or a monovalent substituent.

In this embodiment of the optical information recording medium of the first aspect of the invention, each of A³¹-Y³¹-A³² and A³⁴-Y³²-A³³ is preferably independently an alkylene diamine, a cyclam, a cyclene, or a phenylenediamine.

In another embodiment of the optical information recording medium of the first aspect of the invention, the cationic part is represented by Formula (4), each of the linking groups represented by Y⁴¹, Y⁴², Y⁴³, and Y⁴⁴ is an alkylene group or an arylene group, and the ligand represented by L⁴ is a hydrogen atom or a monovalent substituent.

In this embodiment of the optical information recording medium of the first aspect of the invention, each of A⁴¹-Y⁴¹-A⁴², A⁴²-Y⁴²-A⁴³, A⁴⁶-Y⁴⁴-A⁴⁵, and A⁴⁵-Y⁴³-A⁴⁴ is independently an alkylene diamine, a cyclam, a cyclene, or a phenylenediamine.

According to the above embodiments of the optical information recording medium, because each of the linking groups linking the atoms coordinating in metal atoms are an alkylene group or an arylene group, the absorbance of light having a wavelength of around 400 nm, that is the coloration that affects the recording and reproducing, can be suppressed to be low. Therefore, it can be superior in the recording-and-reproducing characteristic of the electronic information and the light resistance after recording, and effective for the improvement of the durability to reproducing light at reproduction.

In another embodiment of the optical information recording medium of the first aspect of the invention, cationic part is represented by one of the following Formulae (6) or (7).

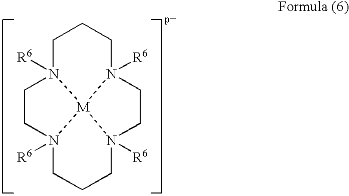

In Formula (6), M represents a metal atom; each of R⁶s independently represents a hydrogen atom or a substituent; and p represents an integer of 1 to 3.

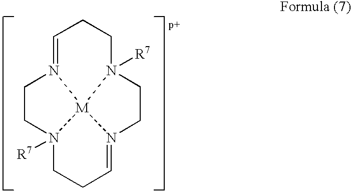

In Formula (7), M represents a metal atom; each of R⁷s independently represents a hydrogen atom or a substituent; and p represents an integer of 1 to 3.

In another embodiment of the optical information recording medium of the first aspect of the invention, a metal atom in the metal complex is selected from the group consisting of Zn, Cu, Ni, Co, Fe and Mn.

According to the above embodiments of the optical information recording medium, it has less absorbance of light having a wavelength of around 400 nm, is substantially colorless due to its configuration, and thus can be effective to suppress the coloration that affects the recording and reproducing of the electronic information. Therefore, it can be superior in the recording-and-reproducing characteristic of the electronic information and the light resistance after recording, and effective for the improvement of the durability to reproducing light at reproduction.

In another embodiment of the optical information recording medium of the first aspect of the invention, the recording layer can perform recording by irradiation with a blue laser beam having a wavelength of 440 nm or less.

According to the above embodiment of the optical information recording medium, it can perform recording with a high recording density, and it is useful for recording and reproducing with a blue laser beam.

In another embodiment of the optical information recording medium of the first aspect of the invention, the recording layer further comprises an oxonol dye represented by the following Formula (5) or an oxonol dye which is a multimer in which two or more molecules, each of which is represented by Formula (5) and may be similar to or different from each other, are linked to each other through any of A, B, C, and D in Formula (5).

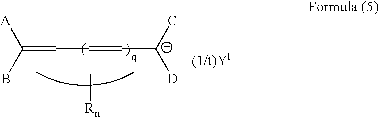

In Formula (5): each of A, B, C, and D independently represents an electron attractive group, A and B or C and D may be linked to each other to form a ring, and the sum of Hammet values (σₚ) of A and B and the sum of Hammet values (σₚ) of C and D are both 0.6 or more when A and B or C and D is not linked to each other; R represents a substituent on a methine carbon; q represents an integer of 0 or 1; n represents an integer of 0 to 2q+1; a plurality of Rs may be the same with or may be different from each other and may form a ring by linking to each other when n is an integer of 2 or more; Y^{t+} represents a t-valent cation; and t represents an integer of 1 to 10.

According to the above embodiment of the optical information recording medium, a recording with a high recording density with a blue laser beam can be performed, and because and the oxonol dye, which is easily discolored by exposure to light, is used in combination with the described metal complex compound of the invention, a superior light resistance can be obtained, and it can be effective to improve the recording-and-reproducing characteristic of the electronic information further.

In another embodiment of the optical information recording medium of the first aspect of the invention, the oxonol dye is represented by the following Formula (8).

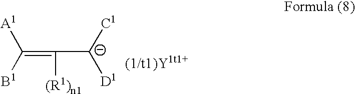

In Formula (8): each of A¹, B¹, C¹, and D¹ independently represents an electron attractive group, A¹ and B¹ or C¹ and D¹ may be linked to each other to form a ring, and the sum of Hammet values (σₚ) of A¹ and B¹ and the sum of Hammet values (σₚ) of C¹ and D¹ are both 0.6 or more when A¹ and B¹ or C¹ and D¹ is not linked to each other; R¹ represents a substituent on a methine carbon; a plurality of R¹s may be the same with or may be different from each other and may form a ring by linking to each other when n is an integer of 2 or more; Y^{1t1+} represents a t1-valent cation; t1 represents an integer of 1 to 10; and n1 represents an integer of 0 or 1.

Each of the preferable scopes of A¹, B¹, C¹, D¹, R¹, Y¹, and t1 are similar to those of A, B, C, D, R, Y, and t in Formula (5) respectively.

According to the above embodiment of the optical information recording medium, the effect of improving the light resistance is high and the recording-and-reproducing characteristic of the electronic information can be effectively promoted.

In another embodiment of the optical information recording medium of the first aspect of the invention, the anionic part of the metal complex compound is an anion derived from an oxonol dye represented by the following Formula (5a) or an anion derived from an oxonol dye which is a multimer in which two or more molecules, each of which is represented by Formula (5a) and may be similar to or different from each other, are linked to each other through any of A, B, C, and D in Formula (5a).

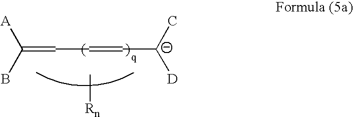

In Formula (5a): each of A, B, C, and D independently represents an electron attractive group, A and B or C and D may be linked to each other to form a ring, and the sum of Hammet values (σₚ) of A and B and the sum of Hammet values (σₚ) of C and D are both 0.6 or more when A and B or C and D is not linked to each other; R represents a substituent on a carbon in methine; q represents an integer of 0 or 1; n represents an integer of 0 to 2q+1; and a plurality of Rs may be the same with or may be different from each other and may form a ring by linking to each other when n is an integer of 2 or more.

According to the above embodiment of the optical information recording medium, because it has a compound structure in which the oxonol dye, which is easily discolored by exposure to light, is provided as an anionic part of the described metal complex compound of the invention, the discoloration of the oxonol dye can be prevented (, namely, the light resistance can be improved), and the recording-and-reproducing characteristic of the electronic information can be effectively improved.

In another embodiment of the optical information recording medium of the first aspect of the invention, the optical information recording medium further comprises a light reflection layer.

In another embodiment of the optical information recording medium of the first aspect of the invention, the optical information recording medium further comprises a protective layer.

In another embodiment of the optical information recording medium of the first aspect of the invention, the substrate is a transparent disk-shaped substrate having a pre-groove on one side thereof with a track pitch of 50 to 500 nm, and the recording layer is provided on the side where the pre-groove is formed.

The second aspect of the invention provides a metal complex formed by salt formation from a cationic part and an anionic part, wherein:

the cationic part is represented by one of Formulae (1) or (2) and its molar absorbance coefficient (s) in the wavelength range of 350 to 1300 nm is 10,000 dm³ mol⁻¹ cm⁻¹ or less when an anionic part is any one of Cl⁻, Br⁻, I⁻, ClO₄⁻, PF₆⁻, BF₄⁻, SO₄²⁻, and CF₃SO₃⁻; and

the anionic part of the metal complex compound is an anion derived from an oxonol dye represented by Formula (5a) or an anion derived from an oxonol dye which is a multimer in which two or more molecules, each of which is represented by Formula (5a) and may be similar to or different from each other, are linked to each other through any of A, B, C, and D in Formula (5a).

According to the above embodiment of the metal complex compound, because the cationic part thereof is a metal complex cation in which the molar absorbance coefficient (∈) in the wavelength range of 50 to 1300 nm is 10,000 dm³ mol⁻¹ cm⁻¹ or less, the absorbance of light having a wavelength of around 400 nm, that means the coloration, decreases, and by combining this cationic part with an anionic part of an oxonol structure as a counter anion, performance of light resistance of the oxonol dye can be improved. Consequently, for example in the case where it is used for a dye component of the recording layer in the optical information recording medium, because the coloration which affects the recording and reproducing of the electronic information can be suppressed, the light resistance and the recording-and-reproducing characteristic can be effectively improved.

In another embodiment of the optical information recording medium of the second aspect of the invention, the cationic part is represented by one of Formulae (3) or (4).

In another embodiment of the optical information recording medium of the second aspect of the invention, a metal atom therein is selected from the group consisting of Zn, Cu, Ni, Co, Fe and Mn.

The above embodiments of the metal complex compound has extremely small absorbance of light having a wavelength of around 400 nm due to its configuration, and can be made to be substantially colorless.

### BRIEF DESCRIPTION OF THE DRAWINGS

FIG. 1 is a graph showing an absorption spectrum of a film formed of an Example compound (1) of a metal complex compound of the invention (a coating film produced by dissolving the compound in 2,2,3,3-tetrafluoro-1-propanol).

FIG. 2 is a graph showing an absorption spectrum of a film formed of an Example compound (17) of a metal complex compound of the invention (a coating film produced by dissolving the compound in 2,2,3,3-tetrafluoro-1-propanol).

FIG. 3 is a graph showing an absorption spectrum of a film formed of a Comparative example compound (A) (a coating film produced by dissolving the compound in 2,2,3,3-tetrafluoro-1-propanol).

FIG. 4 is a graph showing an absorption spectrum of a film formed of a Comparative example compound (B) (a coating film produced by dissolving the compound in 2,2,3,3-tetrafluoro-1-propanol).

### DETAILED DESCRIPTION

The optical information recording medium and the metal complex compound of the invention are explained in detail below.

The optical information recording medium has a substrate and at least one recording layer that is capable of recording information provided on or above a substrate. The optical information recording medium is preferably further provided with an light reflection layer and a protective layer.

The recording layer of the invention includes at least one kind of the metal complex compounds obtained by forming a salt with a cationic part and an anionic part (hereinafter it may be referred to as “the metal complex compound of the invention”). The cationic part of this metal complex compound is formed of a cation, which is derived from a metal complex in which the molar absorbance coefficient (∈) in the wavelength range of 350 to 1300 nM is 10,000 dm³ mol⁻¹ cm⁻¹ or less in a case where the anionic part of this metal complex compound is any one of Cl⁻, Br⁻, I⁻, ClO₄⁻, PF₆⁻, BF₄⁻, SO₄²⁻, and CF₃SO₃⁻.

The metal complex to be the cationic part of the metal complex compound of the invention is explained.

The “metal complex to be the cationic part of the metal complex compound” refers to a moiety having a metal having a positive electric charge and a ligand. The following specific example can be given as one such metal complex compound and the metal complex to be the cationic part.

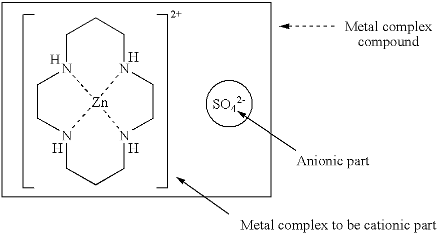

The metal complex to be the cationic part of the metal complex compound of the invention is a metal complex in which the molar absorbance coefficient (∈) in the wavelength range of 350 to 1300 nm is 10,000 dm³ mol⁻¹ cm⁻¹ or less when the anionic part is any one of Cl⁻, Br⁻, I⁻, ClO₄⁻, PF₆⁻, BF₄⁻, SO₄²⁻, and CF₃SO₃⁻. In the invention, because a recording layer with less absorbance around wavelength 400 nm, in another words, less coloration to affect the recording and reproducing of the electronic information, can be formed by specifically selecting a metal complex in which the molar absorbance coefficient (∈) in the wavelength range of 350 to 1300 nm is 10,000 dm³ mol⁻¹ cm⁻¹ or less as a cationic part of the metal complex compound, the recording-and-reproducing characteristic of the electric information is improved, is superior in the light resistance at use after recording, and superior in the durability to reproducing light at reproduction. It is especially useful for recording and reproducing with a blue laser beam of 440 nm or less.

The molar absorbance coefficient (∈) refers to the molar absorbance coefficient described in “Photochemistry I” (Haruo Inoue et al., published by Maruzen Co. Ltd. in 1999).

The molar absorbance coefficient (∈) is a value calculated from an absorbance and a molar concentration of a measuring solution measured by using a spectrophotometer such as UV-3100PC (trade name, manufactured by Shimadzu Corp.).

The molar absorbance coefficient (∈) of the metal complex to be the cationic part of the metal complex compound is 10,000 dm³ mol⁻¹ cm⁻¹ or less in the wavelength range of 350 to 1300 nm when the anionic part is any one of Cl⁻, Br⁻, I⁻, ClO₄⁻, PF₆⁻, BF₄⁻, SO₄²⁻, and CF₃SO₃⁻. For anionic parts that do not have these absorbencies, while the value of the molar absorbance coefficient (∈) of the corresponding metal complex compounds may change a little depending on the kind of the anionic part, it is suitable as long as the molar absorbance coefficient (∈) of a metal complex compound when using Cl⁻, Br⁻, I⁻, ClO₄⁻, PF₆⁻, BF₄⁻, SO₄²⁻, or CF₃SO₃⁻ therewith becomes 10,000 dm³ mol⁻¹ cm⁻¹ or less.

In the metal complex compound of the invention, when the anionic part is any one of Cl⁻, Br⁻, I⁻, ClO₄⁻, PF₆⁻, BF₄⁻, SO₄²⁻, and CF₃SO₃⁻, the molar absorbance coefficient (∈) of the metal complex to be a cationic part in the wavelength range of 350 to 1300 nm is preferably 5,000 dm³ mol⁻¹ cm⁻¹ or less, more preferably 1,000 dm³ mol⁻¹ cm⁻¹ or less, further preferably 500 dm³ mol⁻¹ cm⁻¹ or less, and particularly preferably 200 dm³ mol⁻¹ cm⁻¹ or less.

Examples of the metal atom forming the metal complex include Mg, Al, Si, Ca, Sc, Ti, V, Cr, Mn, Fe, Co, Ni, Cu, Zn, Ga, Ge, As, Sr, Y, Zr, Nb, Mo, Tc, Ru, Rh, Pd, Ag, Cd, In, Sn, Sb, Ba, Pr, Eu, Yb, Hf, Ta, W, Re, Os, Ir, Pt, Au, Hg, Tl, Pb, Bi, and Th.

Among the metal complexes to be a cationic part of the metal complex compound, preferable examples thereof include metal complexes having a thermal decomposition temperature of 250° C. or higher when the anionic part of the metal complex compound is any one of Cl⁻, Br⁻, I⁻, ClO₄⁻, PF₆⁻, BF₄⁻, SO₄²⁻, and CF₃SO₃⁻. While the value of the thermal decomposition temperature of the corresponding metal complex compound may vary a little depending on the kind of the anionic part, it is suitable as long as the thermal decomposition temperature of any one of a metal complex compound when using Cl⁻, Br⁻, I⁻, ClO₄⁻, PF₆⁻, BF₄⁻, SO₄²⁻, or CF₃SO₃⁻ therewith becomes 250° C. or higher.

The thermal decomposition temperature of the metal complex to be a cationic part of the metal complex compound, when any one of Cl⁻, Br⁻, I⁻, ClO₄⁻, PF₆⁻, BF₄⁻, SO₄²⁻, and CF₃SO₃⁻ is arranged therewith as an anionic part of a metal complex compound, is more preferably, in terms of the recording-and-reproducing characteristics, 270° C. or higher, still more preferably 300° C. or higher, and particularly preferably 350° C. or higher.

The “thermal decomposition temperature” means the temperature at which a weight reduction rate is reached 20% in TG/TDA measurement. In the TG/TDA measurement of this case, the temperature is raised at 10° C./min in the range of 30° C. to 550° C. under N₂ gas flow (flow rate: 200 ml/min).

EXSTAR6000 (trade name, manufactured by Seiko Instruments Inc.) can be used for the measurement apparatus.

Among the metal complexes to be a cationic part of the metal complex compound of the invention, a transition metal complex is preferable. The transition metal complex refers to a compound in which a transition metal atom and at least one ligand are bonded. The transition metal atom is an element including elements of group IIIa to group VIII and Ib and having an incomplete d-electron shell. While the transition metal atom is not particularly limited, preferable examples thereof include Mn, Fe, Co, Ni, Cu, Zn, Cr, Ru, Rh, Pd, Ir, Pt, and Re, more preferable examples thereof include Cr, Mn, Fe, Co, Ni, Cu, and Zn, further preferable examples thereof include Mn, Fe, Co, Ni, Cu, and Zn, and particularly preferable examples thereof include Co, Ni, Cu, and Zn.

The anionic part of the metal complex compound of the invention is not particularly limited, and any anionic moiety can be used as the anionic part as long as it has a negative electric charge. Examples thereof include Cl⁻, Br⁻, I⁻, ClO₄⁻, PF₆⁻, BF₄⁻, SO₄²⁻, CF₃SO₃⁻, an anionic part of an oxonol dye, and metal complexes (such as the anionic parts of the metal azo chelate dyes described in JP-A No. 2001-271001, JP-A No. 2005-297407, or the like).

Among these, the anionic part is preferably a metal complex or an anionic part of an oxonol dye, and is more preferably an anionic part of an oxonol dye.

The cationic part of the metal complex compound of the invention is further explained in detail below.

### Metal Complex Cation Represented by Formula (1)

The cationic part of the metal complex compound is preferably a metal complex cation represented by the following Formula (1). Since the metal complex compound of the invention has the metal complex cation represented by Formula (1), the metal complex compound has less absorbance of light having a wavelength of around 400 nm, in other words, less coloration to affect the recording of the electronic information. Accordingly, the recording-and-reproducing characteristic of the electric information and the light resistance of the optical recording medium of the invention and the durability to reproducing light at reproduction can be improved thereby. The utilization of the metal complex cation represented by Formula (1) is particularly useful for recording and reproducing with a blue laser beam of 440 nm or less.

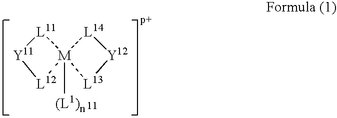

In Formula (1), M represents a metal atom. M preferably represents a divalent and a trivalent metal atom, and more preferably represents a divalent metal atom. Examples of the divalent or the trivalent metal (listed in forms of metal ions) include Mn²⁺, Fe²⁺, Fe³⁺, Co²⁺, Ni²⁺, Cu²⁺, Zn²⁺, Cr³⁺, Ru²⁺, Rh³⁺, Pd²⁺, Ir³⁺, and Pt²⁺. Preferable examples thereof include Mn²⁺, Fe²⁺, Fe³⁺, Co²⁺, Ni²⁺, Cu²⁺, and Zn²⁺, further preferable examples thereof include Mn²⁺, Fe²⁺, Co²⁺, Ni²⁺, Cu²⁺, and Zn²⁺, and more preferable examples thereof include Co²⁺, Ni²⁺, Cu²⁺, and Zn²⁺.

Each of Y¹¹ and Y¹² independently represents a linking group, a single bond, or a double bond.

While the linking group is not particularly limited, examples thereof include an alkylene group, an alkenylene group, an arylene group, a heteroarylene group, a carbonyl linking group, a thiocarbonyl linking group, an oxygen atom linking group, a sulfur atom linking group, a nitrogen atom linking group, and divalent groups formed by combining any of these. When Y¹¹ represents a linking group, the bond between L¹¹ and Y¹¹ and the bond between Y¹¹ and L¹² represents a single bond or a double bond. When Y¹² represents a linking group, the bond between L¹³ and Y¹² and the bond between Y¹² and L¹⁴ represents a single bond or a double bond.

Each of L¹, L¹¹, L¹², L¹³ and L¹⁴ independently represents a ligand. Any of L¹¹ to L¹⁴ may be linked to each other through a linking group other than Y¹¹ and Y¹².

In addition to ligands referred in the followings, preferable examples of the ligand include those described in “Photochemistry and Photophysics of Coordination Compounds” (written by H. Yersin, published by Spriner-Verlag in 1987), “Organic Metal Chemistry—Foundation and Application—” (written by Akio Yamamoto, published by SHOKABO PUBLISHING Co., Ltd. in 1982), or the like. Specific examples thereof include a halogen ligand (such as a chlorine ligand and a fluorine ligand), a diketone ligand (such as an acetylacetone ligand), a nitrile ligand (such as an acetonitrile ligand), a CO ligand, an isonitrile ligand (such as a t-buthylisonitrile ligand), an aqua ligand, and a carboxylic acid ligand (such as an acetic acid ligand).

It is preferable that the ligand does not have absorbance thereof in the wavelength range of 350 to 1300 nm.

Preferable examples of the atom included in the L¹ and L¹¹ to L¹⁴ and coordinated in M include a nitrogen atom, an oxygen atom, a sulfur atom, and a phosphorus atom, and more preferable examples thereof include a nitrogen atom and a phosphorus atom.

In the case where L¹ and L¹¹ to L¹⁴ are coordinated in M, a bond to be formed between M and L¹, and L¹¹ to L¹⁴ may be a covalent bond or a coordinate bond. However, the number of the covalent bonds with M has to be smaller than the number of metal valence electrons (it cannot be a metal complex cation when it is equal to or larger than the number of metal valence electrons). The ligands consisting of L¹¹-Y¹¹-L¹² and L¹³-Y¹²-L¹⁴ are preferably a neutral ligand (which means a ligand in which all bonds between a metal and a ligand are a coordinate bond). The number of the covalent bonds with M is preferably 0.

The L¹ and L¹¹ to L¹⁴ coordinated in M with a nitrogen atom are not particularly limited, and examples thereof include a nitrogen-containing aromatic heterocyclic ligand, an amino ligand, an alkylamino ligand (preferably having 2 to 30 carbon atoms, more preferably having 2 to 20 carbon atoms, and particularly preferably having 2 to 10 carbon atoms, and examples thereof include methylamino, dimethylamino, diethylamino, dibenzylamino, triethylamino, piperidine, piperazine, and morpholine), an arylamino ligand (preferably having 3 to 30 carbon atoms, more preferably having 4 to 20 carbon atoms, and particularly preferably having 5 to 10 carbon atoms, and examples thereof include phenylamino, diphenylamino, and pyridylamino), an acylamino ligand (preferably having 2 to 30 carbon atoms, more preferably having 2 to 20 carbon atoms, and particularly preferably having 2 to 10 carbon atoms, and examples thereof include acetylamino and benzoylamino), an alkoxycarbonylamino ligand (preferably having 2 to 30 carbon atoms, more preferably having 2 to 20 carbon atoms, and particularly preferably having 2 to 12 carbon atoms, and examples thereof include metoxycarbonylamino), an aryloxycarbonylamino ligand (preferably having 7 to 30 carbon atoms, more preferably having 7 to 20 carbon atoms, and particularly preferably 7 to 12 carbon atoms, and examples thereof include phenyloxycarbonylamino), a sulfonylamino ligand (preferably having 1 to 30 carbon atoms, more preferably having 1 to 20 carbon atoms, and particularly preferably having 1 to 12 carbon atoms, and examples thereof include methanesulfonylamino and benzenesulfonylamino), an imino ligand, and a nitrile ligand (preferably, acetonitrile, etc.). These ligands may be substituted.

The nitrogen-containing aromatic heterocyclic ligand is not particularly limited, and examples thereof include a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand, an oxadiazole ligand, a thiadiazole ligand, a condensed ligand body including these (for example, a quinoline ligand, a benzoxazole ligand, benzimidazole ligand, etc.), and a tautomer thereof.

The L¹ and L¹¹ to L¹⁴ coordinating in M with an oxygen atom are not particularly limited, and examples thereof include an alkoxy ligand (preferably having 1 to 30 carbon atoms, more preferably having 1 to 20 carbon atoms, and particularly preferably having 1 to 10 carbon atoms, and examples thereof include a metoxy ligand, an etoxy ligand, a butoxy ligand, and a 2-ethylhexyloxy ligand), an aryloxy ligand (preferably having 6 to 30 carbon atoms, more preferably having 6 to 20 carbon atoms, and particularly preferably 6 to 12 carbon atoms, and examples thereof include a phenyloxy ligand, a 1-naphthyloxy ligand, and a 2-naphthyloxy ligand), a heterocyclic oxy ligand (preferably having 1 to 30 carbon atoms, more preferably having 1 to 20 carbon atoms, and particularly preferably having 1 to 12 carbon atoms, and examples thereof include a pyridyloxy ligand, a pyradyloxy ligand, a pyrimidyloxy ligand, and a quinolyloxy ligand), an acyloxy ligand (preferably having 2 to 30 carbon atoms, more preferably having 2 to 20 carbon atoms, and particularly preferably 2 to 10 carbon atoms, and examples thereof include an acetoxy ligand and a benzoyloxy ligand), a silyloxy ligand (preferably having 3 to 40 carbon atoms, more preferably having 3 to 30 carbon atoms, particularly preferably having 3 to 24 carbon atoms, and examples thereof include a trimethylsilyloxy ligand and a triphenylsilyloxy ligand), a carbonyl ligand, an aminocarbonyl ligand, an ether ligand, a furil ligand, a carbonyloxy ligand, a sulfoxy ligand, and an aqua ligand.

The L¹ and L¹¹ to L¹⁴ coordinating in M with a sulfur atom are not particularly limited, and examples thereof include an alkylthio ligand (preferably having 1 to 30 carbon atoms, more preferably having 1 to 20 carbon atoms, and particularly preferably having 1 to 12 carbon atoms, and examples thereof include a methylthio ligand and an ethylthio ligand), an arylthio ligand (preferably having 6 to 30 carbon atoms, more preferably having 6 to 20 carbon atoms, and particularly preferably having 6 to 12 carbon atoms, and examples thereof include a phenylthio ligand), a heterocyclic thio ligand (preferably having 1 to 30 carbon atoms, more preferably having 1 to 20 carbon atoms, and particularly preferably having 1 to 12 carbon atoms, and examples thereof include a pyridylthio ligand, a 2-benzimizolylthio ligand, a 2-benzoxazolylthio ligand, and a 2-benzthiazolylthio ligand), a thiocarbonyl ligand, a thioether ligand, and a thienyl ligand. These substituents may be further substituted.

The L¹ and L¹¹ to L¹⁴ coordinating in M with a phosphorus atom are not particularly limited, and examples thereof include an alkylphosphino ligand (preferably having 2 to 30 carbon atoms, more preferably having 2 to 20 carbon atoms, and particularly preferably having 2 to 10 carbon atoms, and examples thereof include a methylphosphino ligand, a dimethylphosphino ligand, a diethylphosphino ligand, a and a dibenzylphosphino ligand) and an arylphosphino ligand (preferably having 3 to 30 carbon atoms, more preferably having 4 to 20 carbon atoms, and particularly preferably having 5 to 10 carbon atoms, and examples thereof include a phenylphosphino ligand, a diphenylphosphino ligand, and a pyridylphosphino ligand).

Among these, preferable examples of the ligand represented by any one of the L¹ and L¹¹ to L¹⁴ include an ether ligand, an alkylamino ligand, an arylamino ligand, a pyridine ligand, an alkylphosphino ligand, and an arylphosphino ligand; more preferable examples thereof include an alkylamino ligand, an arylamino ligand, and an arylphosphino ligand; further preferable examples thereof include an alkylamino ligand and an arylamino ligand; and particularly preferable examples thereof include an alkylamino ligand.

Any of the L¹ and L¹¹ to L¹⁴ may be linked to each other through a linking group which is other than Y¹¹ and Y¹², and preferably form a tetra- or higher-dentate ligand by linking to each other.

n¹¹ in Formula (1) represents an integer of 0 to 2, preferably represents 0 or 1, and more preferably represents 0. p represents an integer of 1 to 3, preferably represents 2 or 3, and more preferably represents 2.

### Metal Complex Cation Represented by Formula (2)

In another preferable embodiment of the invention, the cationic part of the metal complex cation can be represented by Formula (2). Since the metal complex compound of the invention having the metal complex cation represented by Formula (2) also has less absorbance of light having a wavelength of around 400 nm, in other words, less coloration to affect the recording of the electronic information, the recording-and-reproducing characteristic of the electric information and the light resistance of the optical recording medium of the invention and the durability to reproducing light at reproduction can be improved. The utilization of the metal complex cation represented by Formula (1) is particularly useful for recording and reproducing with a blue laser beam of 440 nm or less.

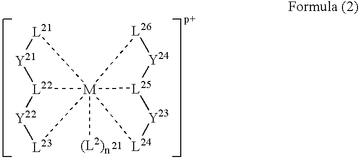

M in Formula (2) has the same meaning as M in Formula (1), and the preferable scope thereof is also similar to that of M in Formula (1).

In Formula (2), each of L² and L²¹ to L²⁶ has the same meaning as that of the L¹ and L¹¹ to L¹⁴ in Formula (1), and the preferable scope of each of L² and L²¹ to L²⁶ is also similar to each of that of the L¹ and L¹¹ to L¹⁴ in Formula (1) respectively. Each of Y²¹ to Y²⁴ has the same meaning as that of the Y¹¹ and Y¹² in Formula (1), and the preferable scope of each of Y²¹ to Y²⁴ is also similar to each of that of the Y¹¹ and Y¹² in Formula (1) respectively. Each of n²¹ and p has the same meaning as each of that of the n¹¹ and p in Formula (1) respectively, and the preferable scope of each of n²¹ and p is also similar to each of that of the n¹¹ and p in Formula (1) respectively.

The L² and L²¹ to L²⁶ may be linked to each other through a linking group which is other than Y²¹ to Y²⁴, and preferably form a hexa- or higher-dentate ligand by linking to each other.

### Metal Complex Cation Represented by Formula (3)

Among the metal complex cations represented by Formula (1), the metal complex cation represented by Formula (3) below is preferable. Because the absorbance around wavelength 400 nm is particularly less so that the coloration to affect the recording of the electronic information can be suppressed, it is effective to improve the light resistance. Therefore, it is superior in the recording-and-reproducing characteristic of the electric information and can promote the durability to reproducing light at reproduction. It is particularly useful for recording and reproducing with a blue laser beam having a wavelength of 440 nm or less.

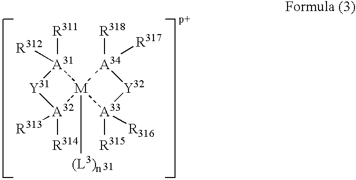

M in Formula (3) has the same meaning as M in Formula (1), and the preferable scope thereof is also similar to that of M in Formula (1).

Each of A³¹, A³², A³³, and A³⁴ independently represents a nitrogen atom or a phosphorus atom, and are preferably represents a nitrogen atom.

Each of Y³¹ and Y³² independently represents a linking group. Each of Y³¹ and Y³² has the same meaning as that of the Y¹¹ or Y¹² in Formula (1) respectively, and the preferable scope of each of these is also similar to each of that of the Y¹¹ and Y¹² in Formula (1) respectively.

Each of R³¹¹, R³¹², R³¹³, R³¹⁴, R³¹⁵, R³¹⁶, R³¹⁷, and R³¹⁸ independently represents a hydrogen atom or a substituent, and the any of R³¹¹ to R³¹⁸ may be linked to each other through a linking group which is other than Y³¹ and Y³².

The substituent represented by R³¹¹ to R³¹⁸ is not particularly limited, and examples thereof include an alkyl group (preferably having 1 to 30 carbon atoms, more preferably having 1 to 20 carbon atoms, particularly preferably having 1 to 10 carbon atoms, and examples thereof include methyl, ethyl, iso-propyl, tert-butyl, n-octyl, n-decyl, n-hexadecyl, cyclopropyl, cyclopentyl, and cyclohexyl), an alkenyl group (preferably having 2 to 30 carbon atoms, more preferably having 2 to 20 carbon atoms, particularly preferably having 2 to 10 carbon atoms, and examples thereof include vinyl, allyl, 2-butenyl, and 3-pentenyl), an alkynyl group (preferably having 2 to 30 carbon atoms, more preferably having 2 to 20 carbon atoms, particularly preferably having 2 to 10 carbon atoms, and examples thereof include propargyl and 3-pentynyl), an aryl group (preferably having 6 to 30 carbon atoms, more preferably having 6 to 20 carbon atoms, particularly preferably having 6 to 12 carbon atoms, and examples thereof include phenyl, p-methylphenyl, naphthyl, and anthranyl), an acyl group (preferably having 1 to 30 carbon atoms, more preferably having 1 to 20 carbon atoms, particularly preferably having 1 to 12 carbon atoms, and examples thereof include acetyl, benzoyl, formyl, and pivaloyl), an alkoxycarbonyl group (preferably having 2 to 30 carbon atoms, more preferably having 2 to 20 carbon atoms, particularly preferably having 2 to 12 carbon atoms, and examples thereof include metoxycarbonyl and etoxycarbonyl), an aryloxycarbonyl group (preferably having 7 to 30 carbon atoms, more preferably having 7 to 20 carbon atoms, particularly preferably having 7 to 12 carbon atoms, and example includes phenyloxycarbonyl), a heterocyclic group (preferably having 1 to 30 carbon atoms, more preferably having 1 to 12 carbon atoms, and examples of a hetero atom include a nitrogen atom, an oxygen atom, and a sulfur atom, and specifically imidazolyl, pyridyl, quinollyl, furyl, thienyl, piperidyl, morphoryno, benzoxazolyl, benzimidazolyl, benzthiazolyl, a carbazolyl group, and an azepinyl group), and a silyl group (preferably having 3 to 40 carbon atoms, more preferably having 3 to 30 carbon atoms, particularly preferably having 3 to 24 carbon atoms, and examples thereof include trimethylsilyl and triphenylsilyl). These substituents may be substituted further.

R³¹¹ to R³¹⁸ is each independently preferably a hydrogen atom, an alkyl group, and an aryl group, and more preferably a hydrogen atom and an alkyl group. Any of the R³¹¹ to R³¹⁸ may be linked to each other through a linking group, and preferably form a tetra- or higher-dentate ligand by linking to each other.

L³ in Formula (3) has the same meaning as the L¹ in Formula (1), and the preferable scope thereof is also similar to that of L¹ in Formula (1). Each of n³¹ and p in Formula (3) has the same meaning as each of the n¹¹ or p in Formula (1) respectively, and the preferable scope of each of n³¹ and p is also similar to each of that of the n¹¹ or p in Formula (1) respectively.

In a preferable embodiment, the linking group represented by each of Y³¹ and Y³² in Formula (3) is respectively an alkylene group or an arylene group, and L³ in Formula (3) is a hydrogen atom or a monovalent substituent. In a particularly preferable embodiment, A³¹-Y³¹-A³² and A³⁴-Y³²-A³³ in Formula (3) are respectively alkylenediamine, cyclam, cyclene, or phenylenediamine.

The alkylene group represented by Y³¹ and Y³² is preferably a substituted or unsubstituted alkylene group having 1 to 10 carbon atoms. Examples thereof include an ethylene group, a propylene group, cis,cis-1,2-cyclohexanediamine and the like, and more preferable examples thereof include an alkylene group having 2 to 6 carbon atoms.

The arylene group represented by Y³¹ or Y³² is preferably a substituted or unsubstituted arylene group having 6 to 12 carbon atoms. Examples thereof include a phenylene group, a naphthalene group and the like, and more preferable examples thereof include an arylene group having 6 to 8 carbon atoms.

L³ has the same meaning as the L¹ and L¹¹ to L¹⁴ in Formula (1), and the preferable scope thereof is also similar to that of L¹ and L¹¹ to L¹⁴ in Formula (1)

An alkyl part of the alkylenediamine preferably has 1 to 10 carbon atoms, and preferable examples of the alkylenediamine include ethylenediamine, propylenediamine, cis-1,2-diaminocyclohexane.

Preferable examples of the A³¹-Y³¹-A³² and A³⁴-Y³²-A³³ include cis-1,2-diaminocyclohexane.

### Metal Complex Cation Represented by Formula (4)

Among the metal complex cations represented by Formula (2), the metal complex cation represented by the following Formula (4) is preferable. Because the absorbance around wavelength 400 nm is particularly less so that the coloration to affect the recording of the electronic information can be suppressed, it is effective to improve the light resistance. Therefore, it is superior in the recording-and-reproducing characteristic of the electric information and can promote the durability to reproducing light at reproduction. It is particularly useful for recording and reproducing with a blue laser beam having a wavelength of 440 nm or less.

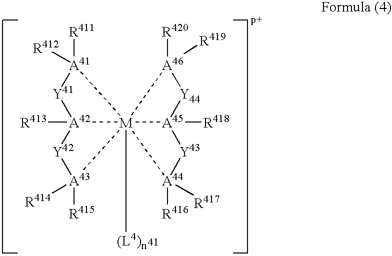

M in Formula (4) has the same meaning as M in Formula (1), and the preferable scope thereof is also similar to that of M in Formula (1).

Each of A⁴¹, A⁴², A⁴³, A⁴⁴, A⁴⁵, and A⁴⁶ in Formula (4) independently represents a nitrogen atom or a phosphorus atom, and the preferable scope of each of these is also similar to each of that of the A³¹ to A³⁴ in Formula (1) respectively.

Each of Y⁴¹, Y⁴², Y⁴³, and Y⁴⁴ independently represents a linking group. Preferable scope of each of Y⁴¹, Y⁴², Y⁴³, and Y⁴⁴ is also similar to each of that of the Y¹¹ and Y¹² in Formula (1) respectively.

Each of R⁴¹¹, R⁴¹², R⁴¹³, R⁴¹⁴, R⁴¹⁵, R⁴¹⁶, R⁴¹⁷, R⁴¹⁸, R⁴¹⁹, and R⁴²⁰ independently represents a hydrogen atom or a substituent, and any of the R⁴¹¹ to R⁴²⁰ may be linked to each other through a linking group which is other than Y⁴¹ to Y⁴⁴. Each of R⁴¹¹ to R⁴²⁰ has the same meaning as that of the R³¹¹ to R³¹⁸ in Formula (3), and the preferable scope of each of the R⁴¹¹ to R⁴²⁰ in Formula (4) is also similar to each of that of the R³¹¹ to R³¹⁸ in Formula (3) respectively.

Any of R⁴¹¹ to R⁴²⁰ may be linked to each other through a linking group, and preferably form a hexa- or higher-dentate ligand by linking to each other.

L⁴ in Formula (4) has the same meaning as the L¹ in Formula (1), and the preferable scope thereof is also the same. Each of n⁴¹ and p in Formula (4) has the same meaning as each of that of the n¹¹ and p in Formula (1) respectively, and the preferable scope of each of n⁴¹ and p is also similar to each of that of the n¹¹ and p in Formula (1) respectively.

In a preferable embodiment, the linking group represented by each of Y⁴¹, Y⁴², Y⁴³, and Y⁴⁴ in Formula (4) is respectively an alkylene group or an arylene group, and L⁴ in Formula (4) is a hydrogen atom or a monovalent substituent. In a particularly preferable embodiment, A⁴¹-Y⁴¹-A⁴², A⁴²Y⁴²-A⁴³, A⁴⁶-Y⁴⁴-A⁴⁵, and A⁴⁵-Y⁴³-A⁴⁴ in Formula (4) are respectively alkylenediamine, cyclam, cyclene, or phenylenediamine.

Each of Y⁴¹ to Y⁴⁴ has the same meaning as each of the alkylene group and the arylene group represented by Y³¹ and Y³² in Formula (3), and the preferred embodiment thereof is also the same respectively. Each of L⁴ and alkylenediamine has the same meaning as L³ and alkylenediamine in Formula (3), and the preferable embodiment thereof is the same respectively. Particularly preferable examples of the A⁴¹-Y⁴¹-A⁴², A⁴²-Y⁴²-A⁴³, A⁴⁶-Y⁴⁴-A⁴⁵, and A⁴⁵-Y⁴³-A⁴⁴ is cis-1,2-diaminocyclohexane.

### Metal Complex Cation Represented by Formula (6) or (7)

Among the above-described metal complex cations, a metal complex cation having a partial structure represented by the following Formula (6) or (7) is further preferable. It is particularly effective in terms that absorbance thereof around wavelength of 400 nm is less, and thus the coloration which affects the recording of the electronic information can be suppressed.

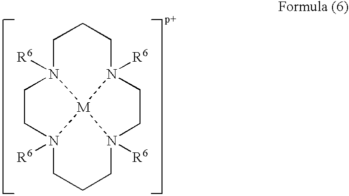

In Formula (6), M has the same meaning as the M in Formula (1), and the preferable scope thereof is also the same. p in Formula (6) has the same meaning as that of the p in Formula (1), and the preferable scope thereof is also the same.

R⁶ in Formula (6) has the same meaning as each of that of the R³¹¹ to R³¹⁸ in Formula (3), and the preferable scope thereof is also the same.

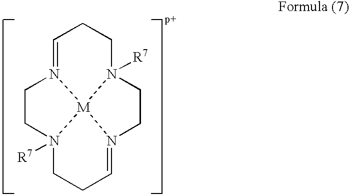

In Formula (7), M has the same meaning as the M in Formula (1), and the preferable scope thereof is also the same. p in Formula (7) has the same meaning as that of the p in Formula (1), and the preferable scope thereof is also the same.

R⁷ in Formula (7) has the same meaning as each of that of the R³¹¹ to R³¹⁸ in Formula (3), and the preferable scope thereof is also the same.

Examples of the metal complex which is a cationic part of the metal complex compound (metal complex cation) represented by Formula (1) (specific examples C-1 to C-50) are shown below. Note that the invention is not limited to these. Examples of the anionic part are not shown because it is not particularly limited. Note that abbreviations are performed in the following examples such as (C-1′) being shown as (C-1) in order to simply represent the same (identical) ligand in the same metal complex.

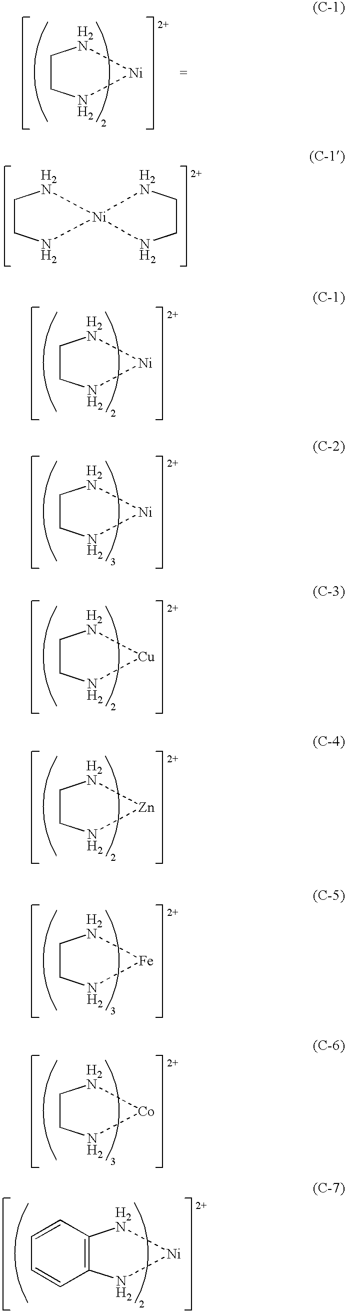

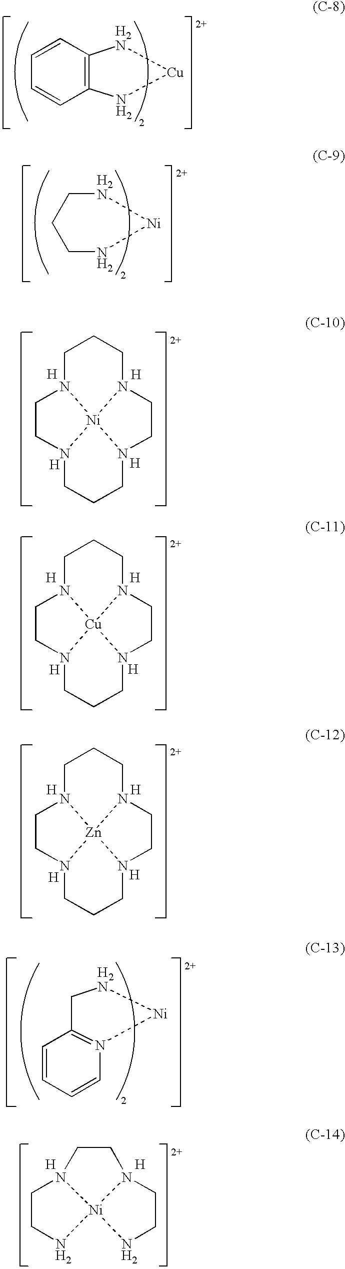

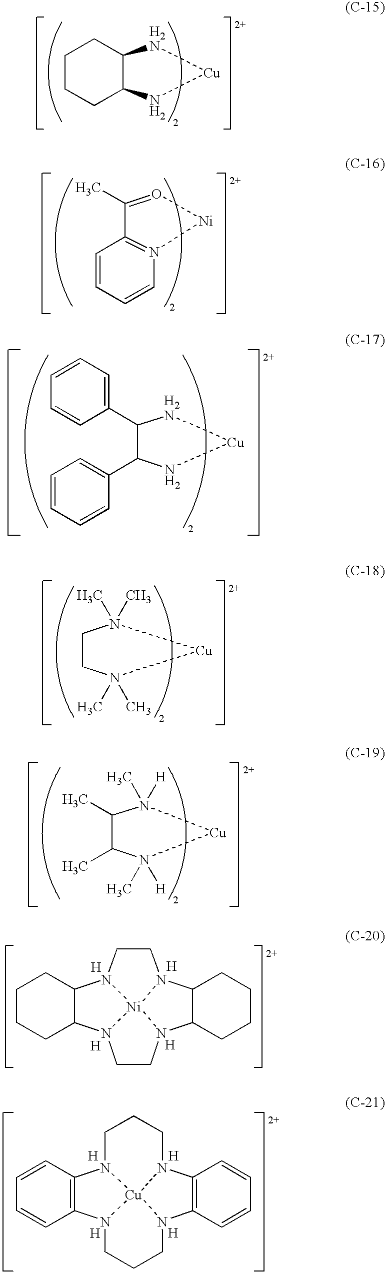

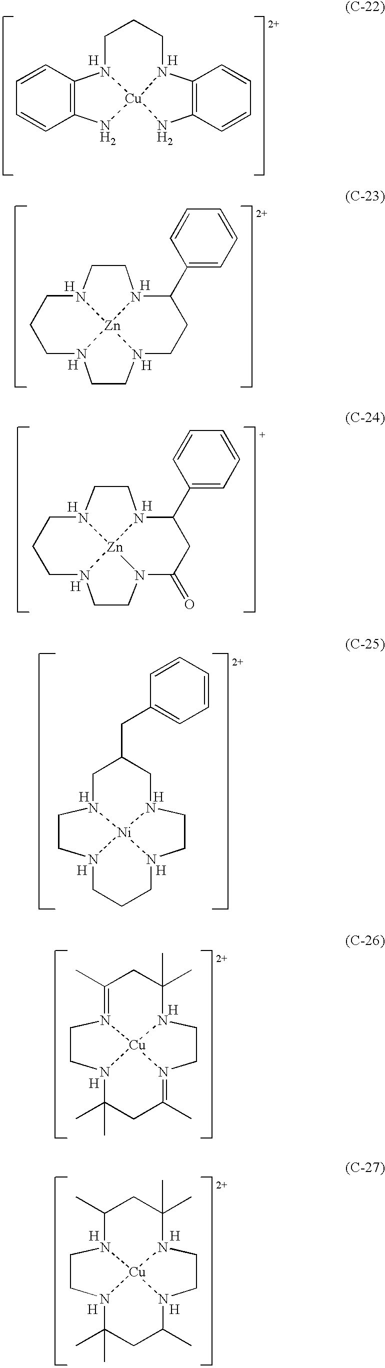

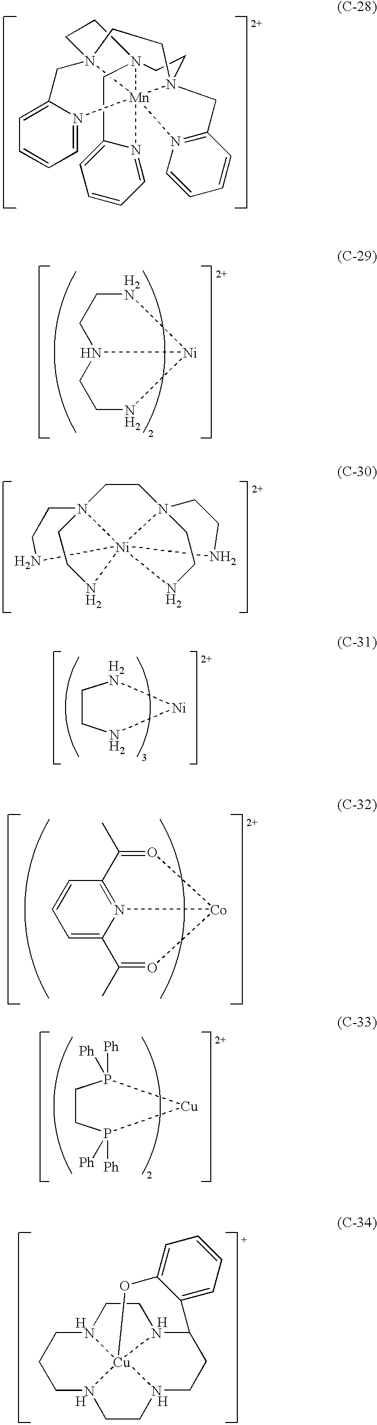

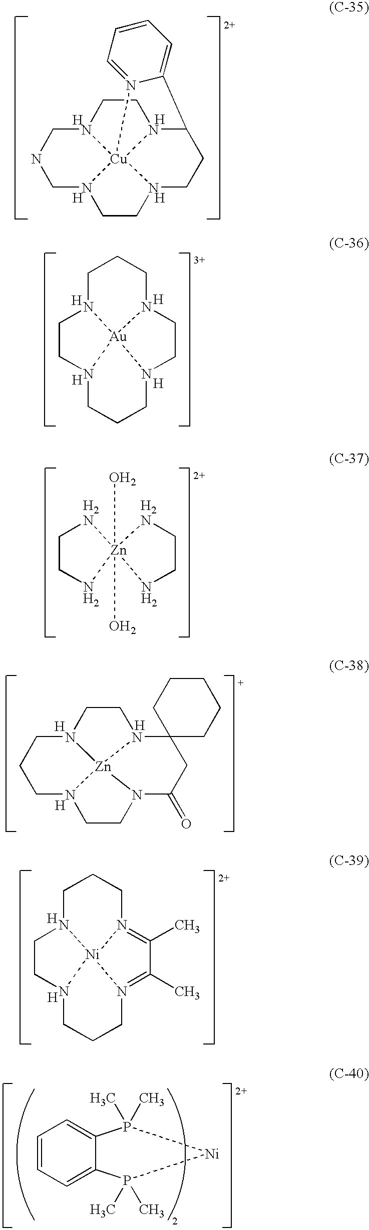

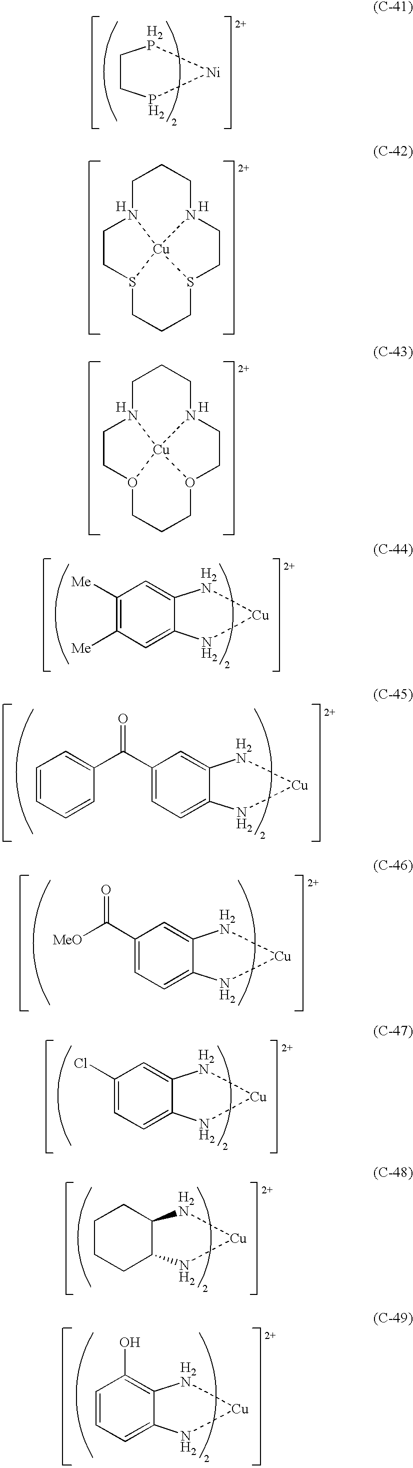

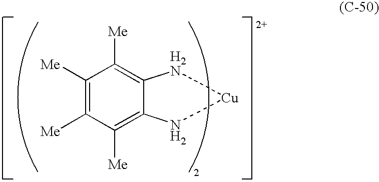

The cationic part of the metal complex compound of the invention is preferably a metal complex (metal complex cation) selected from a group consisting of the above-described specific examples C-1 to C-50, and more preferable examples among these include a metal complex (metal complex cation) selected from a group consisting of C-7, C-8, C-10, C-11, C-12, C-15, C-21, and C-44 to C-50.

Preferable examples of the anionic part of the metal complex compound having the metal complex cation represented by Formula (1) includes an anionic part of the oxonol dye represented by the following Formula (5).

The anionic part of the oxonol dye represented by Formula (5) and specific examples of the metal complex compound obtained by forming a salt of the anionic part of the oxonol dye represented by Formula (5) and the metal complex cation represented by Formula (1) are explained in detail in the explanation of the oxonol dye below.

The amount of the metal complex compound of the invention in the recording layer is preferably in a range of 5 to 70% by mass, and more preferably in a range of 10 to 50% by mass, relative to the mass of the recording substance (including the oxonol dye described below). When the amount of the metal complex compound is within the above-described range, the light resistance and the recording-and-reproducing characteristic can be effectively improved.

The recording layer of the optical information recording medium of the invention is a layer in which the recording and reproducing of code information (encoded information) such as digital information (such as music data) is performed by laser beam, and can be preferably configured to a dye-type recording layer which includes a dye as a recording substance together with the metal complex compound of the invention.

In the case where the metal complex compound of the invention is a compound obtained by forming a salt with the metal complex cation represented by Formula (1) and the anionic part of the oxonol dye represented by Formula (5), other dyes are not necessary to be included in the recording layer, while other dyes can be arbitrarily used as occasions demand.

Specific examples of a dye that is a recording substance include a cyanine dye, an oxonol dye, an azo dye, a phthalocyanine dye, a triazole compound (including a benzotriazole compound), a triazine compound, a merocyanine compound, an aminobutadiene compound, a cinnamic acid compound, a benzoxazole compound, a pyromethene compound, and a squarylium compound. The center of the coordination of each of these may have a metal atom. Specific examples of the dye further include the dyes disclosed in JP-A Nos. 4-74690, 8-127174, 11-53758, 11-334204, 11-334205, 11-334206, 11-334207, 2000-43423, 2000-108513, and 2000-158818.

### Oxonol Dye

Among those described above, the embodiment in which at least one kind of the oxonol represented by the following Formula (5) is used in combination with the metal complex compound in the recording layer of the optical information recording medium of the invention is preferable. This oxonol dye tends to be easily discolored by exposure to light, and it is difficult to maintain the light resistance in the case where it is used as a dye component of the recording layer. However, the utilization of the metal complex compound of the invention in the combination with the oxonol dye can effectively promote the light resistance as well as further improving the recording-and-reproducing characteristic of electric information.

The oxonol dye represented by Formula (5) is explained below.

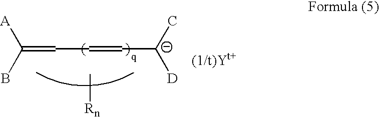

The scope of the oxonol dye represented by Formula (5) includes a plurality of tautomers based upon the difference in notation of a localized position of the anion. In the case where any one of A, B, C, and D in the formula is —CO-E (E is a substituent), it is generally represented with localizing a negative electric charge on an oxygen atom.

For example, in the case where D is —CO-E, Formula (II) below is a general representation, and such representation is included in scope of Formula (5).

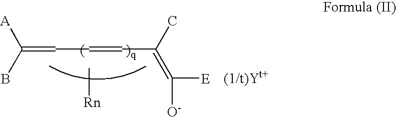

The definitions of each of A, B, C, R, q, n, Y^{t+}, and t in Formula (II) are the same as each of those in Formula (5).

Hereinafter, Formula (5) is explained in detail.

In Formula (5), each of A, B, C, and D independently represents an electron attractive group. A and B or C and D may be linked to each other to form a ring. The sum of Hammet values (σₚ) of A and B and the sum of Hammet values (σₚ) of C and D are both 0.6 or more when A and B or C and D is not linked to each other. A, B, C, and D may be the same with or may be different from each other.

Each of the Hammet substituent constant σₚ value of the electron attractive group represented by any one of the A, B, C, and D is independently preferably in a range of 0.30 to 0.85, and is more preferably in a range of 0.35 to 0.80.

The Hammet substituent constant σₚ value (, that may be simply referred to as “σₚ value” hereinafter,) is described in Chem. Rev. 91, 165 (1991) and the references in this article, and those which are not described can also be obtained in accordance with the method described in the same articles. In the case where A and B (and/or C and D) are linking and forming a ring, the σₚ value of A (and/or C) means the σₚ value of a -A-B-H (and/or C-D-H) group, and the σₚ value of B (and/or D) means the σₚ value of a -B-A-H (and/or D-C—H) group. In this case, the σₚ values are different because the bonding directions of both groups are different.

Specific examples of the electron attractive groups represented by A, B, C, or D include a cyano group, a nitro group, an acyl group having 1 to 10 carbon atoms (such as an acetyl group, a propionyl group, a buthylyl group, a pivaloyl group, or a benzoyl group), an alkoxycarbonyl group having 2 to 12 carbon atoms (such as a metoxycarbonyl group, an etoxycarbonyl group, an isopropoxycarbonyl group, a butoxycarbonyl group, or a decyloxycarbonyl group), an aryloxycarbonyl group having 7 to 11 carbon atoms (such as a phenyloxycarbonyl group), a carbamoyl group having 1 to 10 carbon atoms (such as a methylcarbamoyl group, an ethylcarbamoyl group, or a phenylcarbamoyl group), an alkylsulfonyl group having 1 to 10 carbon atoms (such as a methanesulfonyl group), an arylsulfonyl group having 6 to 10 carbon atoms (such as a benzenesulfonyl group), an alkoxysulfonyl group having 1 to 10 carbon atoms (such as a metoxysulfonyl group), a sulfomoyl group having 1 to 10 carbon atoms (such as an ethylsulfomoyl or a phenylsulfomoyl group), an alkylsulfinyl group having 1 to 10 carbon atoms (such as a methanesulfinyl group or an ethanesulfinyl group), an arylsulfinyl group having 6 to 10 carbon atoms (such as a benzenesulfinyl group), an alkylsufenyl group having 1 to 10 carbon atoms (such as a methanesulfenyl group or an ethanesulfenyl group), an arylsulfenyl group having 6 to 10 carbon atoms (such as a benzenesulfenyl group), a halogen atom, an alkynyl group having 2 to 10 carbon atoms (such as an ethynyl group), a diacylamino group having 2 to 10 carbon atoms (such as a diacetylamino group), a phosphoryl group, a carboxyl group, and a 5-membered or 6-membered heterocyclic group (such as a 2-benzthiazolyl, 2-benzoxazolyl, 3-pyridyl, 5-(1H)-tetrazolyl, or a 4-pyrimidyl group).

In Formula (5), R represents a substituent on a methine carbon, and examples of the “substituent on a methine carbon” represented by R include a chain or a cyclic alkyl group having 1 to 20 carbon atoms (examples thereof include a methyl group, an ethyl group, a n-propyl group, an iso-propyl group, and a n-butyl group), a substituted and a unsubstituted aryl group having 6 to 18 carbon atoms (examples thereof include a phenyl group, a chlorophenyl group, an anisyl group, a toluoyl group, a 2,4-diamyl group, and a 1-naphthyl group), an alkenyl group (examples thereof include a vinyl group and a methylvinyl group), an alkynyl group (examples thereof include an ethynyl group, a 2-methylehynyl group, and a 2-phenylethynyl group), a halogen atom (examples thereof include F, Cl, Br, and I), a cyano group, a hydroxyl group, a carboxyl group, an acyl group (examples thereof include an acetyl group, a benzoyl group, a salicyloyl group, and a pivaloyl group), an alkoxy group (examples thereof include a metoxy group, a butoxy group, and a cyclohexyloxy group), an aryloxy group (examples thereof include a phenoxy group and a 1-naphthoxy group), an alkylthio group (examples thereof include a methylthio group, a buthylthio group, a benzylthio group, and a 3-metoxypropylthio group), an arylthio group (examples thereof include a phenylthio group and a 4-chlorophenylthio group), an alkylsulfonyl group (examples thereof include a methanesulfonyl group and a butanesulfonyl group), and arylsulfonyl group (examples thereof include a benzenesulfonyl group and a paratoluenesulfonyl group), an carbamoyl group having 1 to 10 carbon atoms, an amide group having 1 to 10 carbon atoms, an imide group having 2 to 12 carbon atoms, an acyloxy group having 2 to 10 carbon atoms, an alkoxycarbonyl group having 2 to 10 carbon atoms, and a heterocyclic group (examples thereof include: an aromatic hetero ring such as a pyridyl group, a thienyl group, a furyl group, a thiazolyl group, or a pyrazolyl; and an aliphatic hetero ring such as a pyrrolidine ring, a piperidine ring, a morpholine ring, a pyrane ring, a thiopyrane ring, a dioxane ring, or a dithiorane ring).

Preferable examples of the substituent represented by R include a halogen atom, a chain-shaped or a ring shaped alkyl group having 1 to 8 carbon atoms, an aryl group having 6 to 10 carbon atoms, an alkoxy group having 1 to 8 carbon atoms, and aryloxy group having 6 to 10 carbon atoms, and a heterocyclic group having 3 to 10 carbon atoms. Particularly preferable examples of the substituent represented by R include a chlorine atom, an alkyl group having 1 to 4 carbon atoms (examples thereof include a methyl group, an ethyl group, and an isopropyl group), a phenyl group, an alkoxy group having 1 to 4 carbon atoms (examples thereof include a methoxy group and an ethoxy group), a phenoxy group, and a nitrogen-containing heterocyclic group having 4 to 8 carbon atoms (examples thereof include a 4-pyridyl group, a benzoxazole-2-il group, and a benzothiazole-2-il group).

In Formula (5), n represents an integer of 0 to 2q+1.

A plurality of Rs may be the same with or may be different from each other and may form a ring by linking to each other when n is an integer of 2 or more. In this case, the number of ring constituents is preferably 4 to 8, and is more preferably 5 or 6, and examples of the atom configuring the ring preferably include a carbon atom, an oxygen atom and a nitrogen atom, and more preferable example thereof include a carbon atom.

A, B, C, D, and R may further have a substituent, and examples of the substituent include those which are the same with the examples of the monovalent substituent represented by R in Formula (5).

In view of a thermal decomposition property as a dye to be used in an optical disk, at least one of the combinations of A and B or C and D is preferably linked to form a ring, and it is more preferable that each of the combinations of A and B and C and D is linked to form a ring.

q represents an integer of 0 or 1, and preferably represents 0.

Examples of the substituent represented by E in Formula (II) include those which are the same with the examples of the electron attractive group represented by A, B, C, or D, and the preferable scope thereof is the also same.

Y^{t+} represents a t-valent cation. t represents an integer of 1 to 10. Examples of the cation include a proton, ammonium, phosphonium, pyridinium, diimonium, a metal ion, and a cation of a metal complex. The cation represented by Y^{t+} is preferably a monovalent cation or a divalent cation.

In the invention, the scope of the anionic part of the metal complex compound include an anion derived from an oxonol dye represented by Formula (5) as well as an anion derived from an oxonol dye which is a multimer in which two or more molecules, each of which is represented by Formula (5) and may be similar to or different from each other, are linked to each other through any one of A, B, C, and D in Formula (5), specific examples thereof include the following examplary compound A-10.

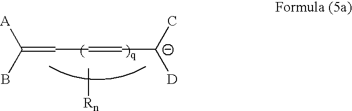

In Formula (5a), each of A, B, C, D, R, q, and n has the same meaning as A, B, C, D, R, q, or n in Formula (5) respectively. Each of the preferable scopes of A, B, C, D, R, q, and n is also similar to that of A, B, C, D, R, q, or n in Formula (5) respectively.

In the invention, the scope of the anionic part of the metal complex compound include an anion derived from an oxonol dye represented by Formula (5a) as well as an anion derived from an oxonol dye which is a multimer in which two or more molecules, each of which is represented by Formula (5a) and may be similar to or different from each other, are linked to each other through any one of A, B, C, and D in Formula (5a).

Preferable examples of the oxonol dyes represented in Formula (5) include the oxonol dye represented in the following Formula (8).

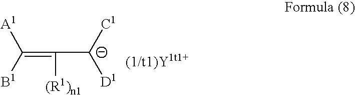

In Formula (8): each of A¹, B¹, C¹, and D¹ independently represents an electron attractive group, A¹ and B¹ or C¹ and D¹ may be linked to each other to form a ring. The sum of Hammet values (σₚ) of A¹ and B¹ and the sum of Hammet values (σₚ) of C¹ and D¹ are both 0.6 or more when A¹ and B¹ or C¹ and D¹ is not linked to each other. R¹ represents a substituent on a methine carbon; a plurality of R¹s may be the same with or may be different from each other and may form a ring by linking to each other when n is an integer of 2 or more; Y^{1t1+} represents a t1-valent cation; t1 represents an integer of 1 to 10; and n1 represents an integer of 0 or 1.

Each of the scopes of A¹, B¹, C¹, D¹, R¹, Y¹, and t1 is similar to that of A, B, C, D, R, Y, or t in Formula (5) respectively.

Specific examples of the anionic part of the oxonol dye represented in Formulas (5) or (8) include the anionic part of the oxonol dye disclosed in JP-A No. 10-297103 and the anions of the following exemplary compounds A-1 to A-10, while the invention is not limited to these.

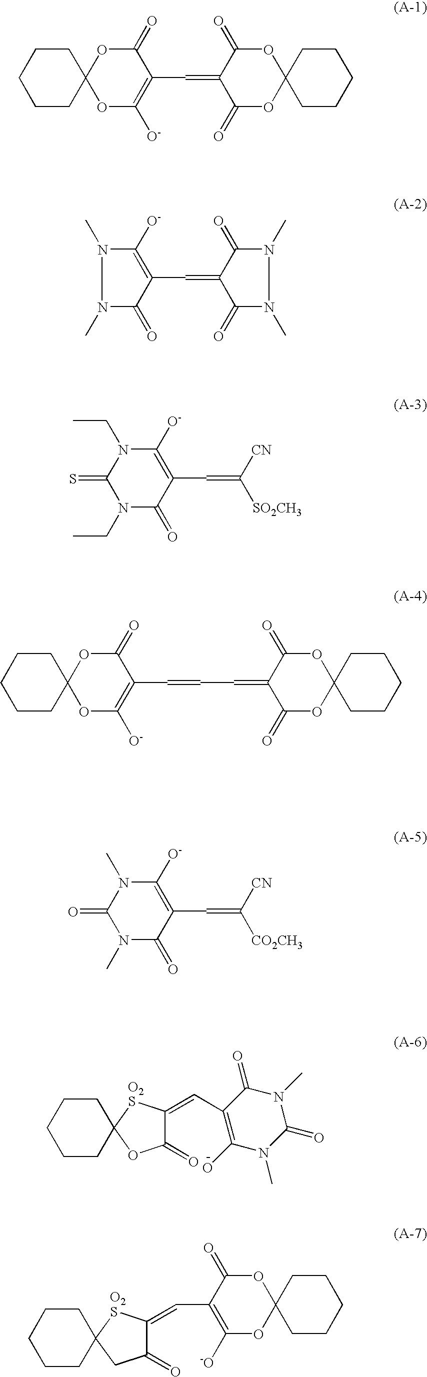

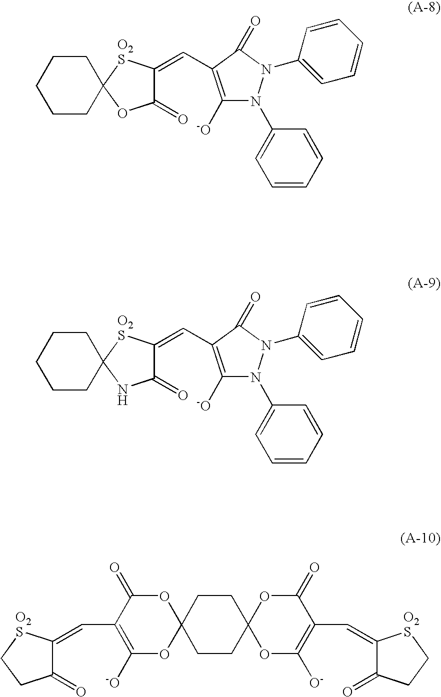

Preferable examples of the metal complex compound of the invention include a salt formed of the metal complex cation represented by Formula (1) and the anionic part of the oxonol dye represented by Formula (5), more preferable examples among those include a salt formed of the cation selected from the group consisting of the specific examples C-1 to C-50 of the metal complex (metal complex cation) and the anionic part of the oxonol dye represented by Formula (5), further preferable examples among those include a salt formed of the cation selected from the group consisting of the specific examples C-1 to C-50 of the metal complex cation and the anionic part of the oxonol dye selected from the group consisting of the specific examples A-1 to A-10, and particularly preferable examples among those include a salt formed of the metal complex cation selected from the group consisting of the specific examples C-7, C-8, C-10, C-11, C-12, C-15, C-21, and C-44 to C-48, and the anionic part of the oxonol dye selected from the group consisting of the specific examples A-6, A-7, and A-8.

Preferable specific examples of the metal complex compound obtained by forming a salt of the metal complex cation represented by Formula (1) and the anionic part of the oxonol dye represented by Formula (5) [Exemplary Compounds (1) to (17)] are shown below, while the invention is not limited to these.

Exemplary compound (1)

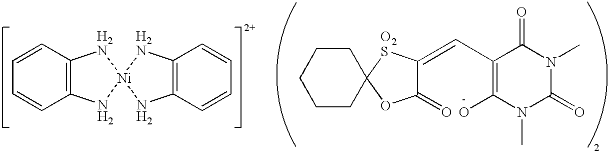

Exemplary compound (2)

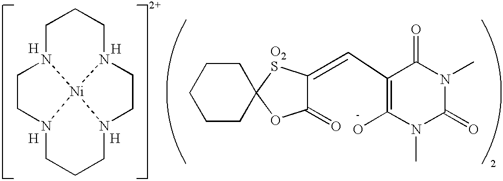

Exemplary compound (3)

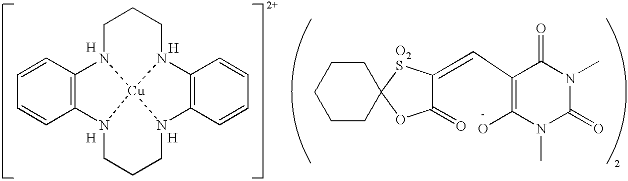

Exemplary compound (4)

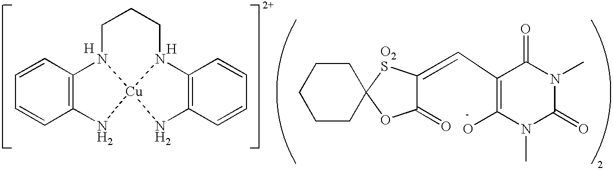

Exemplary compound (5)

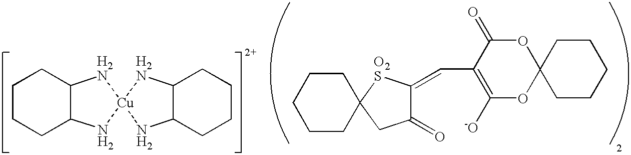

| | Anionic part of oxonol | | Metal complex of |
|---|---|---|---|
| Exemplary compound | dye | t | cationic part (Y) |
| Exemplary compound (6) | Specific example A-6 | 2 | Specific example C-11 |
| Exemplary compound (7) | Specific example A-6 | 2 | Specific example C-12 |
| Exemplary compound (8) | Specific example A-8 | 2 | Specific example C-15 |
| Exemplary compound (9) | Specific example A-7 | 2 | Specific example C-17 |
| Exemplary compound (10) | Specific example A-8 | 1 | Specific example C-24 |
| Exemplary compound (11) | Specific example A-8 | 2 | Specific example C-26 |
| Exemplary compound (12) | Specific example A-7 | 2 | Specific example C-29 |
| Exemplary compound (13) | Specific example A-6 | 2 | Specific example C-30 |
| Exemplary compound (14) | Specific example A-6 | 1 | Specific example C-34 |
| Exemplary compound (15) | Specific example A-9 | 2 | Specific example C-10 |
| Exemplary compound (16) | Specific example A-6 | 2 | Specific example C-13 |
| Exemplary compound (17) | Specific example A-10 | 2 | Specific example C-29 |

*1: The column of the anionic part of the oxonol dye shows the specific examples of the anionic part of the oxonol dye represented by Formula (5).
*2: The column of the metal complex of the cationic part shows the specific examples of the metal complex cation represented by Formula (1).

The metal complex compound obtained by forming a salt of the metal complex cation represented by Formula (1) and the anionic part of the oxonol dye represented by Formula (5) may be prepared by a process including at least synthesizing a metal complex having a structure represented in Formula (1) in accordance with a generally-used method based on documents such as “Experimental Chemistry Lecture” (fourth edition: published by the Chemical Society of Japan), dissolving this metal complex into an appropriate solvent, adding an oxonol dye (the anionic part is optional) represented by Formula (5) thereto, stirring, precipitating, filtering the precipitate, and washing the precipitate.

A concentration of the recording material (specifically, a concentration of the oxonol dye) in the coating solution is generally in the range of 0.01 to 15 mass percent, preferably in the range of 0.1 to 10 mass percent, more preferably in the range of 0.5 to 5 mass percent, and most preferably in the range of 0.5 to 3 mass percent.

The optical information-recording medium of the invention preferably has a conformation of either of the following aspects (1) and (2).

An optical information-recording medium according to an aspect (1) of the invention is an optical information-recording medium having a dye-containing write-once recording layer and a cover layer having a thickness of 0.01 to 0.5 mm in that order on a substrate having a thickness of 0.7 to 2 mm.

An optical information-recording medium according to an aspect (2) of the invention is an optical information-recording medium having a dye-containing write-once recording layer and a protective substrate having a thickness of 0.1 to 1.0 mm in that order on a substrate having a thickness of 0.1 to 1.0 mm.

In the aspect (1), the pre-groove formed on the substrate preferably has a track pitch of 50 to 500 nm, a groove width of 25 to 250 nm, and a groove depth of 5 to 150 nm.

In the aspect (2), the pre-groove formed on the substrate preferably has a track pitch of 200 to 600 nm, a groove width of 50 to 300 nm, a groove depth of 30 to 200 nm, and a wobble amplitude of 10 to 50 nm.

The optical information-recording medium of aspect (1) has at least a substrate, a write-once recording layer and a cover layer, and components of these will be described first one by one.

### Substrate According to Aspect (1)

A pre-groove (guide groove) having the shape with a track pitch, a groove width (half value width), a groove depth, and a wobble amplitude, which are all in the ranges shown below, is formed on the substrate in the aspect (1). The pre-groove is formed for giving the substrate with a recording density higher than that of CD-R or DVD-R, and is particularly preferable, for example when the optical information-recording medium according to the invention is used as a medium compatible with blue purple laser.

The pre-groove track pitch is preferably in the range of 50 to 500 nm, and the upper limit of the range is preferably 420 nm or less, more preferably 370 nm or less, and still more preferably 330 nm or less. The lower limit of the range is preferably 100 nm or more, more preferably 200 nm or more, and still more preferably 260 nm or more. A track pitch of less than 50 nm may lead to difficulty in forming the pre-groove accurately, generating a problem of crosstalk, while that of more than 500 nm may cause a problem of decrease in recording density.

The pre-groove width (half value width) is preferably in the range of 25 to 250 nm, and the upper limit thereof is preferably 240 nm or less, more preferably 230 nm or less, and still more preferably 220 nm or less. The lower limit thereof is preferably 50 nm or more, more preferably 80 nm or more, and still more preferably 100 nm or more. A pre-groove width of less than 25 nm may result in insufficient transfer of the groove during molding and increase in the error rate during recording, while that of more than 250 nm may result in insufficient transfer of the groove during molding and broading the pit formed during recording, causing crosstalk.

The pre-groove depth is preferably in the range of 5 to 150 nm, and the upper limit thereof is preferably 85 nm or less, more preferably 80 nm or less, and still more preferably 75 nm or less. The lower limit thereof is preferably 10 nm or more, more preferably 20 nm or more, and still more preferably 28 nm or more. A pre-groove depth of less than 5 nm may result in insufficient recording modulation, while that of more than 150 nm may result in drastic decrease in reflectance.

An upper limit of an angle of the pre-groove is preferably 80° or less, more preferably 75° or less, still more preferably 70° or less, and particularly preferably 65° or less. Furthermore, a lower limit of the angle of the pre-groove is preferably 20° or more, more preferably 300 or more, and still more preferably 40° or more.

A pre-groove angle of less than 20° may result in insufficient tracking error signal amplitude, while that of more than 80° may result in difficulty in molding.

Various materials which are conventionally-used as substrate materials for optical information recording medium can be arbitrarily selected and used as the substrate used in the invention.

Specific examples of the material include glass; polycarbonates; acrylic resins such as polymethylmethacrylate; vinyl chloride resins such as polyvinyl chloride or vinyl chloride copolymer; epoxy resins; amorphous polyolefins; polyesters; and metals such as aluminum, and a combination of two or more kinds thereof may be used in accordance with necessity.

Among the materials mentioned above, from viewpoints of the moisture resistance, the dimensional stability and the low cost, thermoplastic resins such as amorphous polyolefins and polycarbonate are preferable, and polycarbonate is particularly preferable. In the case of such resins being used, a substrate can be manufactured by means of injection molding.

It is required that a thickness of the substrate is in the range of 0.7 to 2 mm. Preferably it is in the range of 0.9 to 1.6 mm, and more preferably in the range of 1.0 to 1.3 mm.

On a surface of the substrate that is on a side where an light reflection layer mentioned below is disposed, an undercoat layer is preferably formed in order to improve the planarity and to increase the adhesive force.

Examples of the materials of the undercoat layer include polymers such as polymethyl methacrylate, acrylate-methacrylate copolymers, styrene-maleic anhydride copolymers, polyvinyl alcohol, N-methylol acrylamide, styrene-vinyl toluene copolymers, chlorosulfonated polyethylene, cellulose nitrate, polyvinyl chloride, chlorinated polyolefin, polyester, polyimide, vinyl acetate-vinyl chloride copolymers, ethylene-vinyl acetate copolymers, polyethylene, polypropylene or polycarbonate; and a surface modifier such as silane coupling agents.

The undercoat layer can be formed by preparing a coating solution by dissolving or dispersing the material mentioned above in an adequate solvent, followed by coating the coating solution on the surface of the substrate by means of a coating method such as a spin coat method, a dip coat method or an extrusion coat method.

In general, a film thickness of the undercoat layer is in the range of 0.005 to 20 μm, and preferably in the range of 0.01 to 10 μm.

### Write-Once Recording Layer According to Aspect (1)

A write-once recording layer in the aspect (1) is prepared by preparing a coating solution by dissolving a dye together with a binder and others in a suitable solvent, and forming a coated film by coating the coating solution on a substrate or the light reflection layer described below, and drying the coated film. Here, the write-once recording layer may be either mono-layered or multi-layered. In the case of the write-once recording layer having a multi-layered configuration, the recording layer can be formed by carrying out the coating a plurality of times.

A concentration of the dye in the coating solution is generally in the range of 0.01 to 15 mass percent, preferably in the range of 0.1 to 10 mass percent, more preferably in the range of 0.5 to 5 mass percent, and most preferably in the range of 0.5 to 3 mass percent.

Examples of the solvent for the coating solution include esters such as butyl acetate, ethyl lactate or cellosolve acetate; ketones such as methyl ethyl ketone, cyclohexanone, or methyl isobutyl ketone; chlorinated hydrocarbons such as dichloromethane, 1,2-dichloroethane or chloroform; amides such as dimethylformamide; hydrocarbons such as methylcyclohexane; ethers such as tetrahydrofuran, ethyl ether, or dioxane; alcohols such as ethanol, n-propanol, isopropanol, n-buthanol, or diacetone alcohol; fluorinated solvents such as 2,2,3,3-tetrafluoropropanol; and glycol ethers such as ethylene glycol monomethyl ether, ethylene glycol monoethyl ether or propylene glycol monomethyl ether.

The solvents mentioned above may be used singularly or in a combination of two or more kinds thereof in consideration of the solubility of the dye used therewith. The coating solution may furthermore contain various kinds of the additives such as an antioxidant, a UV absorbent, a plasticizer or a lubricant in accordance with the purpose.

Examples of the coating method include a spray method, a spin coat method, a dip method, a roll coat method, a blade coat method, a doctor roll method and a screen print method.

A temperature of the coating solution at the time when coating is performed is preferably in the range of 23 to 50 degrees centigrade, more preferably in the range of 24 to 40 degrees centigrade, and particularly preferably in the range of 23 to 50 degrees centigrade.

A thickness of the write-once recording layer is, on the land (the projected portion on the substrate), preferably 300 nm or less, more preferably 250 nm or less, further more preferably 200 nm or less, and particularly preferably 180 nm or less. A lower limit thereof is preferably 1 nm or more, more preferably 3 nm or more, further more preferably 5 nm or more, and particularly preferably 7 nm or more.

Furthermore, a thickness of the write-once recording layer is, on a groove (the concavity portion on the substrate), preferably 400 nm or less, more preferably 300 nm or less, and further more preferably 250 nm or less. A lower limit thereof is preferably 10 nm or more, more preferably 20 nm or more, and further more preferably 25 nm or more.

Still furthermore, a ratio of a thickness of the write-once recording layer on the land relative to a thickness of the write-once recording layer on the groove (a thickness of the write-once recording layer on the land/a thickness of the write-once recording layer on the groove) is preferably 0.1 or more, more preferably 0.13 or more, further more preferably 0.15 or more, and particularly preferably 0.17 or more. An upper limit thereof is preferably less than 1, more preferably 0.9 or less, further more preferably 0.85 or less, and particularly preferably 0.8 or less.

In the case where the coating solution contains a binder, examples of the binder include natural organic polymers such as gelatin, cellulose derivatives, dextran, rosin or rubber; and synthetic organic polymers such as hydrocarbonic resins such as polyethylene, polypropylene, polystylene or polyisobutylene, vinyl resins such as polyvinylchloride, polyvinylidene chloride or polyvinylchloride-polyvinyl acetate copolymers, acrylic resins such as polymethyl acrylate or polymethyl methacrylate, or initial condensates of thermosetting resins such as polyvinyl alcohol, chlorinated polyethylene, epoxy resin, butyral resin, rubber derivatives or phenol formaldehyde resin. In the case where the binder is additionally used as a component of the recording layer, an amount of the binder used is generally in the range of 0.01 to 50 times an amount of that of the dye (mass ratio), and more preferably in the range of 0.1 to 5 times the amount of that of the dye (mass ratio).

Various kinds of the fading resistance agents can be contained in the recording layer of the information recording medium of the invention in view of increasing the light resistance of the recording layer. A singlet oxygen quencher is generally used as the fading resistance agent. Examples of the singlet oxygen quencher include those described in JP-A No. 64-40382.

An amount of the fading resistance agent such as the singlet oxygen quencher is generally in the range of 0.1 to 50 mass percent, preferably in the range of 0.5 to 45 mass percent, more preferably in the range of 3 to 40 mass percent and particularly preferably in the range of 5 to 25 mass percent, relative to an amount of the dye.

### Cover Layer According to Aspect (1)

A cover layer according to the aspect (1) is bonded on the write-once recording layer described above or a barrier layer described below via an adhesive or a tackifier.

While there is no particular restriction on the cover layer used in the invention as long as a film for forming the cover layer is made from a transparent material, preferable examples of the material include polycarbonates; acrylic resins such as polymethyl methacrylate; vinyl chloride resins such as polyvinylchloride or vinyl chloride copolymers; epoxy resins; amorphous polyolefins; polyester; and cellulose triacetate. Among these, polycarbonate or cellulose triacetate can be preferably used.

“Transparent” used herein means to have 80 percent or more of the transmittance to light used for recording and reproducing.

Various kinds of additives can be further included in the cover layer as long as the effect of the invention is not disturbed thereby. For example, the cover layer may include a UV absorbent that cuts light whose wavelength is 400 nm or less and/or a dye that cuts light whose wavelength is 500 nm or more.

Furthermore, with regard to the physical properties of a surface of the cover layer, the surface roughness is preferably 5 nm or less in both the two-dimensional roughness parameter and the three-dimensional roughness parameter.

From a viewpoint of the collecting power of light used in recording and reproducing, the birefringence of the cover layer is preferably 10 nm or less.

While a thickness of the cover layer is appropriately provided in consideration of a wavelength of the laser light irradiated for recording and reproducing and the NA, in the invention, it is preferably in the range of 0.01 to 0.5 mm, and more preferably in the range of 0.05 to 0.12 mm.

A total layer thickness, that is a sum of layer thicknesses of the cover layer and a layer formed of an adhesive agent or a tackifier, is preferably in the range of 0.09 to 0.11 mm, and more preferably in the range of 0.095 to 0.105 mm.

A protective layer (a hard coat layer) may be disposed on the light incidence surface of the cover layer in order to protect the light incidence surface from being flawed while an optical information recording medium is manufactured.

Preferable examples of the adhesive that is used to bond the cover layer include a UV curable resin, EB curable resin and a thermosetting resin, and particularly preferable examples thereof include the UV curable resin.

In the case where the UV curable resin is used as the adhesive, the UV curable resin may be supplied, on a surface of a barrier layer, in a form of either as it is or in a form of a coating solution prepared by dissolving the UV curable resin in an adequate solvent such as methyl ethyl ketone or ethyl acetate using a dispenser. In order to prevent the manufactured optical information recording medium from warping, the UV curable resin constituting the adhesive layer preferably has a small rate of curing contraction. Examples of such UV curable resin include UV curable resins such as “SD-640” (trade name, manufactured by Dainippon Ink and Chemicals, Inc.).

Preferable example of the method for applying the adhesive include a method including coating a predetermined amount of the adhesive on a bonded surface made of a barrier layer, disposing thereon a cover layer, evenly spreading the adhesive between the bonded layer and the cover layer by means of spin coating, and curing the adhesive.

A thickness of the adhesive layer made of such adhesive is preferably in the range of 0.1 to 100 μm, more preferably in the range of 0.5 to 50 μm, and further more preferably in the range of 10 to 30 μm.

Examples of the tackifier used to bond the cover layer include an acrylic tackifier, a rubber tackifier and a silicon tackifier. From viewpoints of the transparency and the durability, the acrylic tackifiers are preferable among these. Examples of such acrylic tackifiers include those which contain 2-ethylhexyl acrylate or n-butyl acrylate as a main component thereof, and further contain, in view of increasing the cohesive force, copolymers of a short chain alkyl acrylate or short chain methacrylate such as methyl acrylate, ethyl acrylate or methyl methacrylate, and acrylic acid, methacrylic acid, acrylamide compound, maleic acid, hydroxylethyl acrylate and glycidyl acrylate, all of which can work as a crosslinking point with a cross-linking agent. By properly regulating a blending ratio and the kinds of the main component, the short chain component and the component for adding the cross-linking point, the glass transition temperature (Tg) and cross-linking density can be varied.

Examples of the cross-linking agent which can be used together with the tackifier include an isocyanate cross-linking agent. Examples of the isocyanate cross-linking agent include isocyanates such as trilene diisocyanate, 4,4′-diphenylmethane diisocyanate, hexamethylene diisocianate, xylylene diisocyanate, naphthylene-1,5-diisocyanate, o-toluidine isocyanate, isohorone diisocyanate or triphenylmethane triisocyanate; reaction products of these isocyanates and polyalcohols; and polyisocyanates produced by the condensation of the isocyanates. Examples of commercially available products of the isocyanates include: CORONATE L, CORONATE HL, CORONATE 2030, CORONATE 2031, MILLIONATE MR and MILLIONATE HTL (all trade names, manufactured by Nippon Polyurethane Industry Co. Ltd.); TAKENATE D-102, TAKENATE D-110N, TAKENATE D-200 and TAKENATE D-202 (all trade names, manufactured by Takeda Chemical Industries Co., Ltd.); and DESMODULE L, DESMODULE IL, DESMODULE N and DESMODULE HL (all trade names, manufactured by Sumitomo Bayer Co., Ltd.).

The method for applying the tackifier may include a method which includes uniformly coating a predetermined amount of the tackifier on the surface which is to be bonded and is formed of the barrier layer, disposing thereon a cover layer, and curing. Alternatively, method for applying the tackifier may include preparing a tackifier coated-film in advance by coating a predetermined amount of the tackifier on one surface of the cover layer, laminating the tackifier coated-film to the surface to be bonded, and curing.

A commercially available adhesive film, on which a tackifier layer is disposed in advance, may be used as the cover layer.

A thickness of the tackifier layer made of the tackifier is preferably in the range of 0.1 to 100 μm, more preferably in the range of 0.5 to 50 μm, and further more preferably in the range of 10 to 30 μm.

### Other Layers According to Aspect (1)

In addition to the indispensable layers mentioned above, the optical information recording medium according to the aspect (1) may arbitrarily have another layer(s) as long as the effect of the invention is not damaged thereby. Examples of the another layer(s) include a label layer having a desired image formed on the reverse side of the substrate (the opposite side to the side where the write-once recording layer is formed), a light reflection layer (described below) disposed between the substrate and the write-once recording layer, a barrier layer (described below) disposed between the write-once recording layer and the cover layer, and an interface layer disposed between the light reflection layer and the write-once recording layer. The label layer can be formed by using UV curing resins, thermosetting resins, thermal dry resins or the like.

All of the indispensable layers as well as the optional layers can be a singular layer or may have a multi-layered structure.

### Light Reflection Layer According to Aspect (1)

In the optical information recording medium according to the aspect (1), in order to increase the reflectance to the laser light or to impart a function for improving the recording and reproducing properties, a light reflection layer is preferably disposed between the substrate and the write-once recording layer.

The light reflection layer can be formed on a substrate by vacuum evaporation, sputtering or ion plating a light reflective material having high reflectance to the laser light.

A layer thickness of the light reflection layer is generally in the range of 10 to 300 nm and preferably in the range of 50 to 200 nm.

The reflectance is preferably 70 percent or more.

Examples of the light reflective materials having a high reflectance include metals and metalloids such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn or Bi, and stainless steel. The light reflective materials may be used singularly, in combinations of two or more kinds thereof, or in a form of alloy thereof. Among these, Cr, Ni, Pt, Cu, Ag, Au, Al and stainless steel are preferable. Particularly preferable examples thereof include Au, Ag, Al and alloys thereof, and most preferable examples thereof include, Au, Ag and alloys thereof.

### Barrier Layer (Intermediate Layer) According to Aspect (1)

In the optical information recording medium according to the aspect (1), it is preferable to form a barrier layer between the write-once recording layer and the cover layer.

The barrier layer is disposed in view of increasing the storage stability of the write-once recording layer, increasing the adhesiveness between the write-once recording layer and the cover layer, controlling the reflectance, controlling the thermal conductivity and the like.

While there is no restriction on materials used for the barrier layer as long as these are materials that can transmit light that is used for recording and reproducing and also can exhibit the above functions, general examples thereof include a material low in the permeability of gas and water, and preferable examples thereof include dielectrics.

Specifically preferable examples thereof include materials made of nitrides, oxides, carbides and sulfides of Zn, Si, Ti, Te, Sn, Mo and Ge. Among these, ZnS, MoO₂, GeO₂, TeO, SiO₂, TiO₂, ZnO, ZnS—SiO₂, SnO₂ and ZnO—Ga₂O₃, and more preferable examples thereof include ZnS—SiO₂, SnO₂, ZnO—Ga₂O₃ and SiO₂.

The barrier layer can be formed by a vacuum film formation method such as vacuum evaporation, DC sputtering, RF sputtering or ion plating. Among these, it is preferable to use the sputtering method.

A thickness of the barrier layer according to the invention is preferably in the range of 1 to 200 nm, more preferably in the range of 2 to 100 nm, and further more preferably in the range of 3 to 50 nm.

Hereinafter, the optical information-recording medium of the aspect (2) will be described.

The optical information-recording medium of the aspect (2) is an optical information-recording medium having a layer lamination structure, and typical examples of the layer structure are as follows:

(1) First layer structure has a write-once recording layer, a light reflection layer, and an adhesive layer formed in this order on a substrate, and further has a protective substrate formed on the adhesive layer.

(2) Second layer structure has a write-once recording layer, a light reflection layer, a protective layer, and an adhesive layer formed in this order on a substrate, and further has a protective substrate formed on the adhesive layer.

(3) Third layer structure has a write-once recording layer, a light reflection layer, a protective layer, an adhesive layer, and another protective layer formed in this order on a substrate, and further has a protective substrate formed on the protective layer.

(4) Fourth layer structure has a write-once recording layer, a light reflection layer, a protective layer, an adhesive layer, another protective layer, and another light reflection layer formed in this order on a substrate, and further has a protective substrate formed on the light reflection layer.

(5) Fifth layer structure has a write-once recording layer, a light reflection layer, an adhesive layer, and a light reflection layer formed in this order on a substrate, and further has a protective substrate formed on the light reflection layer.

The layer structures (1) to (5) are mere exemplifications, and the layer structure of the invention is not limited to those described above. Orders of some of the layers may be changed, and one or more of the layers may be eliminated. Additional write-once recording layer may be formed on a side on which the protective substrate is provided, and in such a case, an optical information-recording medium allowing recording and reproduction from both sides is obtained. Further, each layer may be a single layer or may contain multiple layers.

Hereinafter, the optical information-recording medium according to the aspect (2) of the invention will be described by referring to a configuration which has a write-once recording layer, a light reflection layer, an adhesive layer, and a protective substrate formed in that order on a substrate as an example.

### Substrate According to Aspect (2)

A pre-groove (guide groove) having the shape having a track pitch, a groove width (half value width), a groove depth, and a wobble amplitude, all of which are in the following ranges, is formed on the substrate of the aspect (2). The pre-groove is formed for giving the substrate with a recording density higher than that of CD-R or DVD-R, and is particularly favorable in cases such as that where the optical information-recording medium according to the invention is used as a medium compatible with blue purple laser.

The pre-groove track pitch is in the range of 200 to 600 nm, and the upper limit thereof is preferably 450 nm or less, and more preferably 450 nm or less. The lower limit thereof is preferably 300 nm or more, more preferably 330 nm or more, and still more preferably 370 nm or more. In a case where the track pitch is less than 200 nm, it may become difficult to accurately form the pre-groove and may cause a problem of crosstalk, while in a case where the track pitch is more than 600 nm, it may cause a problem of deterioration in recording density.

The pre-groove width (half value width) is in the range of 50 to 300 nm, and the upper limit thereof is preferably 290 nm or less, and more preferably 280 nm or less, and still more preferably 250 nm or less. The lower limit thereof is preferably 100 nm or more, more preferably 120 nm or more, and still more preferably 140 nm or more. In a case where the pre-groove width is less than 50 nm, it may lead to insufficient transfer of the groove during molding, and may lead to increase in the error rate during recording, while in a case where the pre-groove width is more than 300 nm, it may lead to broading of the pit formed during recording, which may cause problems of crosstalk, insufficient modulation and the like.

The pre-groove depth is in the range of 30 to 150 nm, and the upper limit thereof is preferably 140 nm or less, more preferably 130 nm or less, and still more preferably 120 nm or less. The lower limit is preferably 40 nm or more, more preferably 50 nm or more, and still more preferably 60 nm or more. In a case where the pre-groove depth is less than 30 nm, it may lead to insufficient recording modulation, while in a case where the pre-groove depth is more than 200 nm, it may lead to drastic decrease in reflectance.

Any one of various materials used for the substrates in conventional optical information-recording media may be properly selected and used in production of the substrate for use in the aspect (2), and specific examples and preferable examples thereof are similar to those described for the substrate in the aspect (1).

The thickness of the substrate is in the range of 0.1 to 1.0 mm, preferably in the range of 0.2 to 0.8 mm, and more preferably in the range of 0.3 to 0.7 mm.

An undercoat layer is preferably formed on a surface side of the substrate on which the write-once recording layer described below is to be formed in view of improvements in planarity and adhesive strength, and specific examples and preferable examples of the materials, coating methods and layer thickness of the undercoat layer are similar to those described for the undercoat layer in the aspect (1).

### Write-Once Recording Layer According to Aspect (2)

Details of the write-once recording layer in the aspect (2) are the same as those of the write-once recording layer in the aspect (1).

### Write-Once Recording Layer According to Aspect (2)

In the aspect (2) of the invention, in order to increase the reflectance to the laser light or to impart a function of improving the recording and reproducing properties, a light reflection layer is preferably disposed on the write-once recording layer.

Details of the light reflection layer of aspect (2) are the same as those of the light reflection layer of the aspect (1).

### Adhesive Layer According to Aspect (2)

The adhesive layer in the aspect (2) is a layer that is arbitrarily formed for improving the adhesion between the light reflection layer and the protective substrate.

The material for the adhesive layer is preferably a photocurable resin, and a photocurable resin having low curable shrinkage is particularly preferable in view of prevention of disk warpage.

Examples of the photocurable resins include UV-curable resins (UV-curable adhesives) such as “SD-640”, “SD-347” (both trade names, manufactured by Dainippon Ink and Chemicals, Inc.), or the like. The thickness of the adhesive layer is preferably in the range of 1 to 1000 μm in view of providing the layer with a sufficient elasticity.

### Protective Substrate According to Aspect (2)

Substrates which are formed of materials which can be used for the above-described substrates and has the same shape as that of the above-described substrates can be used as the protective substrate in the aspect (2) (dummy substrate). The thickness of the protective substrate should be in the range of 0.1 to 1.0 mm, preferably in the range of 0.2 to 0.8 mm, and still more preferably in the range of 0.3 to 0.7 mm.

### Protective Layer According to Aspect (2)

The optical information-recording medium of the aspect (2) may have a protective layer for physical and chemical protection of the light reflection layer, write-once recording layer, or the like, depending on its layer structure.

Examples of the materials for the protective layer include inorganic materials such as ZnS, ZnS—SiO₂, SiO, SiO₂, MgF₂, SnO₂, or Si₃ N₄; and organic materials such as thermoplastic resin, thermosetting resin, or UV-curable resin.

The protective layer can be prepared, for example, by bonding a film prepared by extrusion of a plastic resin with an adhesive onto a light reflection layer. Alternatively, it may be formed by another method such as vacuum deposition, sputtering, or coating.

In a case where the protective layer is made of a thermoplastic resin or thermosetting resin, the method for forming the protective layer may include preparing a coating solution by dissolving the resin in a suitable solvent and coating and drying the coating solution. In a case where a UV-curable resin is used, the method for forming the protective layer may include preparing a coating solution by using the resin as it is or by dissolving it in a suitable solvent, coating the coating solution, and hardening the coated film by UV irradiation. Various additives such as antistatic agent, antioxidant, or UV absorbent may be additionally added to such a coating solution in accordance with its object.

The thickness of the protective layer is generally in the range of 0.1 μm to 1 mm.

### Other Layers According to Aspect (2)

In the optical information recording medium of the aspect (2), as long as the effect of the invention is not disturbed, other optional layers can be included in addition to the indespensable layers described above. Details of the other optional layers are the same as those of the other layers in the aspect (1).

The method for recording electronic information to the optical information-recording medium (hereinafter sometimes referred as an “optical information-recording method”) is explained below.

The optical information-recording method according to an aspect of the invention is performed by using the optical information-recording medium in the aspect (1) or (2). Examples thereof include a method include the following method. First, a beam for recording such as semiconductor laser is irradiated on the optical information-recording medium, while rotating at a constant linear velocity (0.5 to 10 m/sec) or a constant angular velocity, from the cover layer side or from the substrate side. It is thought that the information is recorded, as the photoirradiation raises the temperature in local regions of the recording layer because of absorption of the light, resulting in change in physical or chemical properties (for example, pit formation) thereof. In the invention, a semiconductor laser light having an oscillation wavelength of 440 nm or less is used as the recording light. Examples of preferable light sources include a bluish-purple semiconductor laser having an oscillation wavelength ranging from 390 to 415 nm and a bluish-purple SHG laser having a central oscillation wavelength of 425 nm obtained by halving the wavelength of an infrared semiconductor laser, whose central oscillation wavelength is 850 nm, using a optical waveguide element. The bluish-purple semiconductor laser having an oscillation wavelength ranging from 390 to 415 nm is particularly preferable in terms of recording density. Recorded information can be played back by irradiating the medium with the semiconductor laser from the side of the protective layer or from the side of substrate, while rotating the medium at the same constant linear velocity as mentioned above and detecting the reflected light.

The metal complex compound of the invention can be preferably applied for the use as a dye component of the recording layer for recording and reproducing electric information of an optical information recording medium. The metal complex compound of the invention can be also preferably applied for uses such as a medical application, a fluorescent brightening agent, a material for photography, a UV absorbing material, a laser dye, a dye for color filter, a color conversion filter, a thermal transfer recording material, an ink or the like.

### EXAMPLES

While the invention is further specifically explained with the examples hereinafter, the invention is not limited to these, and any modifications are allowed as long as the essential feature of the invention is not changed thereby. “Part” used herein is based on mass as long as there is no specific notice.

### Example 1

### Synthesis of Exemplary Compound (7) of Metal Complex Compound

(1) Zn cyclam (M-5) shown below was synthesized in the same manner as the synthesis method of a bis(ethylenediamine)copper (II) salt described in “Experimental Chemistry Lecture” (fourth edition, vol. 17, p. 178: published by the Chemical Society of Japan). H₂O included in the molecule is not shown in the following scheme.

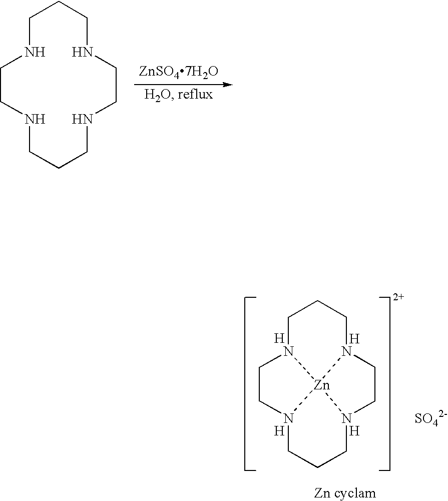

(2) Further, in accordance with the following reaction scheme, 0.3 g of the obtained Zn cyclam (M-5) was dissolved into 8 ml of water. 0.4 g of compound (a) was added thereto and stirred so as to form a precipitate. By filtering this precipitate and washing with water, 0.36 g of the aimed metal complex compound (Exemplary Compound (7)) was obtained.

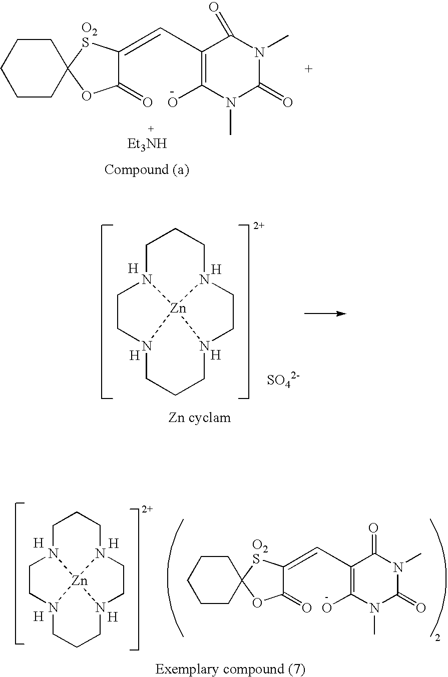

The structure of the thus-obtained metal complex compound (Exemplary compound (7)) was confirmed by ¹H-NMR (300 MHz) to be ¹H-NMR (DMSO-d⁶) [ppm]; 8.0 (s), 3.4-3.3 (m), 3.2-3.1 (d), 2.9 (d), 2.8 (d), 2.6-2.5 (dd), 2.2 (t), 1.8-1.7 (m), and 1.6-1.2 (m).

### Example 2

### Synthesis of Exemplary Compound (2) of Metal Complex Compound

Exemplary compound (2) was synthesized in the same manner as for Exemplary compound (7) in Example 1, except that the following metal complex (M-2) was used in place of the Zn cyclam (M-5).

### Example 3

### Synthesis of Exemplary Compound (1) of Metal Complex Compound

Exemplary compound (1) was synthesized in the same manner as for Exemplary compound (7) in Example 1, except that the following metal complex (M-1) was used in place of the Zn cyclam (M-5).

### Example 4

### Synthesis of Exemplary Compound (4) of Metal Complex Compound

Exemplary compound (4) was synthesized in the same manner as for Exemplary compound (7) in Example 1, except that the following metal complex (M-3) was used in place of the Zn cyclam (M-5).

### Example 5

### Synthesis of Exemplary Compound (5) of Metal Complex Compound

Exemplary compound (5) was synthesized in the same manner as for Exemplary compound (7) in Example 1, except that the following metal complex (M-6) was used in place of the Zn cyclam (M-5), and the following compound (b) was used in place of the compound (a).

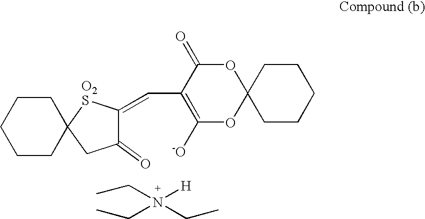

### Example 6

### Synthesis of Exemplary Compound (6) of Metal Complex Compound

Exemplary compound (6) was synthesized in the same manner as for Exemplary compound (7) in Example 1, except that the following metal complex (M-4) was used in place of the Zn cyclam (M-5).

### Example 7

### Synthesis of Exemplary Compound (8) of Metal Complex Compound

Exemplary compound (8) was synthesized in the same manner as for Exemplary compound (7) in Example 1, except that the following metal complex (M-6) was used in place of the Zn cyclam (M-5), the following compound (c) was used in place of the compound (a), and the reaction between the metal complex (M-6) and the compound (c) was performed in a mixture liquid containing water and methanol in a volume ratio of 1:1.

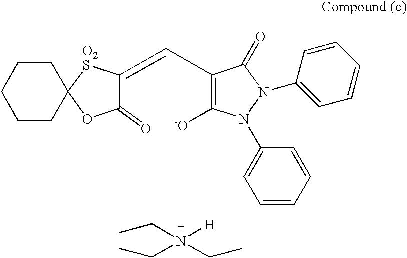

### Example 8

### Synthesis of Exemplary Compound (15) of Metal Complex Compound

Exemplary compound (15) was synthesized in the same manner as for Exemplary compound (7) in Example 1, except that the following metal complex (M-8) was used in place of the Zn cyclam (M-5), the following compound (d) was used in place of the compound (a), and the reaction between the metal complex (M-8) and the compound (d) was performed in a mixture liquid containing water and methanol in a volume ratio of 1:1.

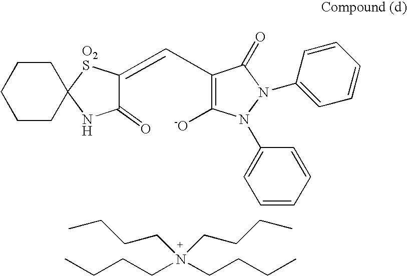

### Example 9

### Synthesis of Exemplary Compound (17) of Metal Complex Compound

Exemplary compound (17) was synthesized in the same manner as for Exemplary compound (7) in Example 1, except that the following metal complex (M-7) was used in place of the Zn cyclam (M-5), the following compound (e) was used in place of the compound (a), and the reaction between the metal complex (M-7) and the compound (e) was performed in a mixture liquid containing water and methanol in a volume ratio of 1:1.

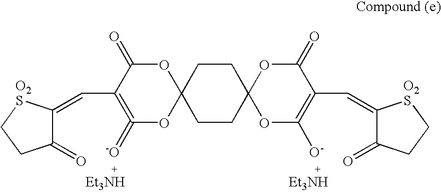

### Measurement and Evaluation

### 1. Molar Absorbance Coefficient (∈)

The molar absorbance coefficients (∈) of compounds in which the metal complexes of the Exemplary compounds (1), (2), (4), (5), (6), (7), (8) and (15) are respectively provided as a cationic part thereof and one of SO₄²⁻, Br⁻, and Cl⁻ is provided as an anionic part thereof [that is, the following complexes (M-1) to (M-8)], Compound B-1 in which an anionic part thereof is Cl⁻ and a cationic part thereof is biologen (biologen is used as a cationic part of the following Compound (A)), a mixture of Compound B-1 and a nickel complex (a), and the following Compound (B) (nickel complex: a metal complex compound for comparison) were measured as follows.

The measurements were performed under the condition of room temperature using UV-3100PC (trade name, manufactured by Shimadzu Corporation). The measurement results are shown in the following Table 1. A solvent to be used for dissolving each measured compound was selected from H₂O, 2,2,3,3-tetrafluoro-1-propanol, and 1,2-dichloroethane, and each is shown in the notes in the following Table 1.

### 2. Thermal Decomposition Temperature

TG/DTA measurements were performed on for the respective metal complexes that are to be the cationic part of the metal complex compound of the invention synthesized in Examples 1 to 8 [Exemplary Compounds (1), (2), (4), (5), (6), (7), (8), and (15)] in the same manner as described in the above “1. Molar absorbance coefficient (∈)” by using the Compounds (M-1) to (M-8) shown below.

In the measurement, EXSTAR6000 (trade name, manufactured by Seiko Instruments Inc.) was used, the temperature was increased at the rate of 10° C./min in the range of 30° C. to 550° C. under a N₂ gas stream (flow rate: 200 ml/min), the temperature when the proportional reduction in mass reached 20% was read and defined as the thermal decomposition temperature. The measurement results are shown in the following Table 1.

### 3. Absorption Spectrum of the Dye

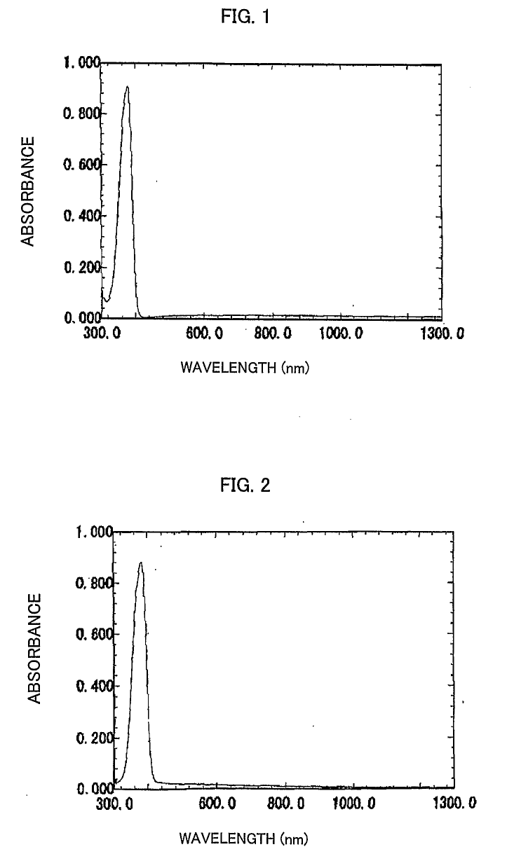

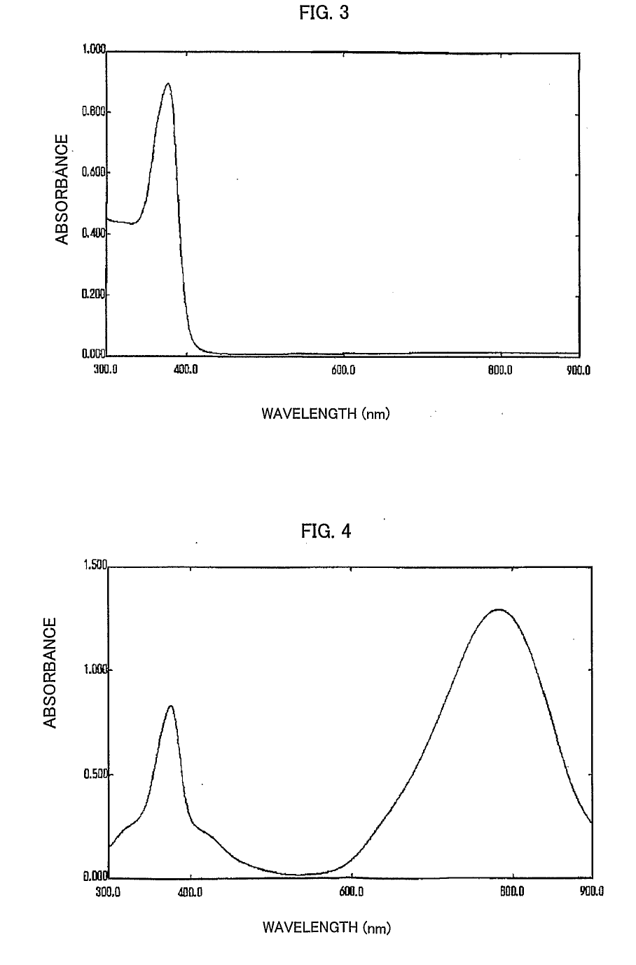

The dye-containing solutions, obtained by adding and dissolving 2 g of each of the metal complex compounds of the invention synthesized in Examples 3 and 9 [Exemplary Compounds (1) and (17)], the following Comparative Compound (A) and the following Comparative Compound (B) in 100 ml of 2,2,3,3-tetrafluoro-1-propanol, were respectively applied and dried so that a thickness of each of the dried layers formed thereby is in a range of about 0.05 to 0.2 μm, and each of the film absorption spectrum of the coating films after drying was measured using a UV-3100PC (described above). The measurement results are shown in FIGS. 1 to 4.

As seen from the results shown in FIGS. 1 to 4, the metal complex to be the cationic part in the metal complex compound of the invention did not exhibit evident absorption in the wavelength range at a longer wavelength range than that in which the absorption of the anionic part of the dye is observed.

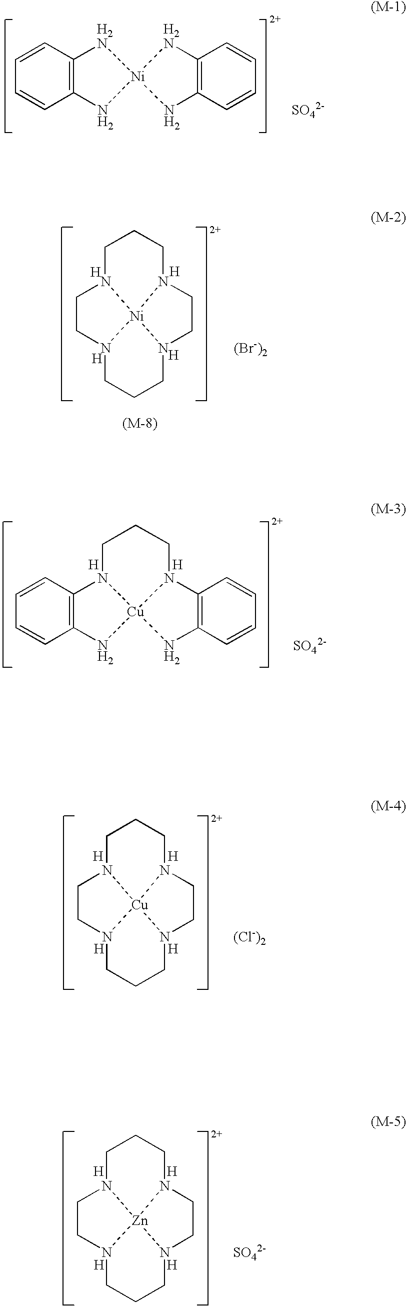

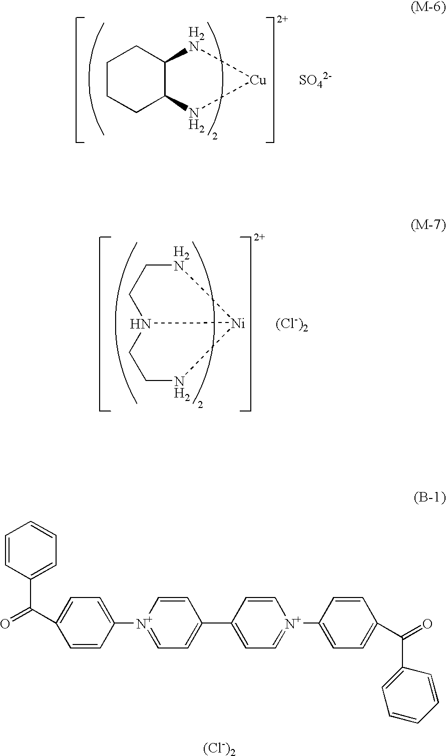

### Examples 10 to 17

### Preparation of Optical Information Recording Medium

### Preparation of Substrate

A injection-molded substrate consisting of a polycarbonate resin with 0.6 mm thickness, 120 mm outer diameter, and 15 mm inner diameter and having a spiral pregroove (track pitch: 400 nm, groove width: 170 nm, groove depth: 100 nm, groove inclined angle: 65°, and wobble amplitude: 20 nm) was prepared. Mastering of the stamper used for injection molding in preparation of the substrate was performed using laser cutting (351 nm).

### Formation of a Write-Once Recording Layer

2 g of each of the metal complex compounds synthesized in the above-described Examples [Exemplary Compounds (1), (2), (4), (5), (6), (7), (8), and (15)] was dissolved into 100 ml of 2,2,3,3-tetrafluoro-1-propanol so as to prepare eight dye-containing coating liquids. The prepared dye-containing coating liquids were respectively applied on the side having the pregroove of each individual substrate obtained above with a spin coating method while the rotation speed was changed from 300 to 4,000 r.p.m. under the condition of 23° C. and 50% RH. Then, the resultants were maintained for one hour at 23° C. and 50% RH so as to form write-once recording layers.

After the write-once recording layers were formed, an annealing process was performed in a clean oven. The annealing process was performed by supporting the substrates with vertical stack poles while spaces were left with spacers and maintaining these for one hour at 80° C.

### Formation of an Light Reflection Layer

An APC light reflection layer (Ag: 98.1% by mass, Pd: 0.9% by mass, and Cu: 1.0% by mass) having a 100 nm film thickness, which is as a vacuum film forming layer, was formed on each of the write-once recording layers by DC sputtering in an Ar environment using a sputtering machine (trade name: CUBE, manufactured by Unaxis Inc.).

### Lamination of Protective Substrate

A UV curing resin (trade name: SD661, described above) was applied on each of the light reflection layers by spin coating so as to form an adhesive layer, and a protective substrate made of polycarbonate (properties thereof are similar to the above-described substrate except that a pregroove was not formed) was laminated thereon. The UV curing resin was cured by irradiating a UV ray. The optical information recording media of the invention were thus manufactured. The thickness of each of the adhesive layer consisting of the UV curing resin was 25 μm.

### Comparative Examples 1 to 3

The comparative optical information recording media of Comparative Examples 1 to 3 were manufactured in the same manner as Example 10 except the metal complex compound used for “formation of a write-once recording layer” in Example 10 was changed to the following Comparative Compound (A) (in Comparative Example 1), a mixture of Comparative Compound A and the nickel complex (a) (Compound (a): the nickel complex (a)=8:2 [mass ratio]) (in Comparative Example 2), or Comparative Compound (B) (in Comparative Example 3).

### Measurement and Evaluation

The evaluations shown below were performed on the optical information recording medium manufactured in Examples 10 to 17 and Comparative Examples 1 to 3. The results of the measurement evaluation are shown in the following Table 1.

### 1. Recording and Reproducing Characteristics (Light Resistance)

C/N (carrier-to-noise ratio) was obtained and defined as an indicator for evaluating the recording and reproducing characteristics (light resistance).

A signal of 0.204 μm (2T) was recorded on each of the optical information recording media manufactured in the Examples and Comparative Examples and reproduced at a clock frequency 64.8 MHz and line speed 6.61 m/s using a recording and reproducing evaluation device equipped with a 405 nm laser and NA0.65 pickup (trade name: DDU1000, manufactured by Pulstec Industrial Co., Ltd.), and the C/N (dB) after the recording was measured with a spectrum analyzer (trade name: TR4171, manufactured by Advantest Corp.). The recording was performed on the groove, and reproducing power was 0.5 mW. The optical information recording medium after recording was then irradiated with xenon light for 12 hours using a light resistance testing device (trade name: FAL-25AX-HCBECL, using a quartz+#275 filter, manufactured by SUGA TEST INSTRUMENTS CO., LTD), and then reproducing was performed again, and the C/N (dB) after the irradiation was measured in the same manner as described above.

When the C/N value is 25 dB or more, the reproduced signal intensity is sufficient and shows that the recording characteristic is good.

### 2. Durability

After each of the optical information recording media was recorded in the same manner as the “1. Recording-and-reproducing characteristic” cited above, continuous reproduction was performed for 30 minutes and the C/N (dB) after the recording and reproducing was measured with the spectrum analyzer (trade name: TR4171, previously mentioned) (a reproduction test).

TABLE 1

| | | | | | | Recording- |
|---|---|---|---|---|---|---|
| | | | Thermal | | Recording- | and- |
| | | | decomposition | | and- | reproducing |
| | | | temperature of | | reproducing | characteristic |
| | | Molar | Cationic part | | characteristic | (After |
| | | absorbance | (° C.) | | (Before | irradiating |
| | | coefficient at | [structure of | Recording | irradiating | Xe lamp for |
| | Metal complex | 350 nm or | the measured | power | with Xe lamp) | 12 hours) |
| | compound | more [ε] | complex] | (mW) | C/N (dB) | C/N (dB) |
| Example 10 | Exemplary | <100* | 317**** | 10 | 40 | 28 |
| | compound (1) | | [(M-1)] | | | |
| Example 11 | Exemplary | <100* | 364***** | 10 | 39 | 30 |
| | compound (2) | | [(M-2)] | | | |
| Example 12 | Exemplary | <200* | 254**** | 10 | 43 | 28 |
| | compound (4) | | [(M-3)] | | | |
| Example 13 | Exemplary | <100* | 327****** | 10 | 40 | 27 |
| | compound (6) | | [(M-4)] | | | |
| Example 14 | Exemplary | <100* | 415**** | 10 | 40 | 25 |
| | compound (7) | | [(M-5)] | | | |
| Example 15 | Exemplary | <100* | 303**** | 10 | 35 | 26 |
| | compound (5) | | [(M-6)] | | | |
| Example 16 | Exemplary | <100* | 370****** | 10 | 32 | 25 |
| | compound (8) | | [(M-6)] | | | |
| Example 17 | Exemplary | <100* | 364**** | 10 | 35 | 25 |
| | compound (15) | | [(M-8)] | | | |
| Comparative | Comparative | 16,220** | — | 6 | 45 | 15 |
| example 1 | Compound (A) | | | | | |
| Comparative | Comparative | >20,000*** | — | 8 | 22 | 18 |
| example 2 | Compound (A) + | | | | | |
| | Nickel complex | | | | | |
| | (a) | | | | | |
| Comparative | Comparative | 176,000** | — | 6 | 20 | 18 |
| example 3 | Compound (B) | | | | | |

Notes
*Measured in a H₂O solution
**Measured in a 2,2,3,3-tetrafluoro-1-propanol solution
***Nickel complex (a) was measured in a 1,2-dichloroethane solution.
****The anionic part is SO₄²⁻.
*****The anionic part is Br⁻.
******The anionic part is Cl⁻.
Comparative compound (A)

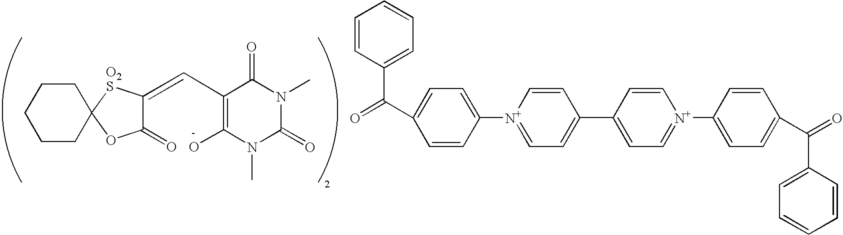

Nickel complex (a)

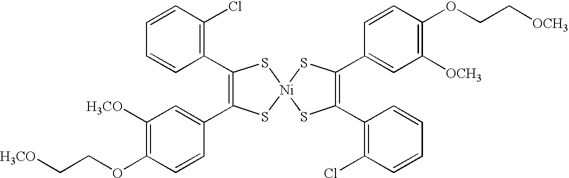

Comparative compound (B)

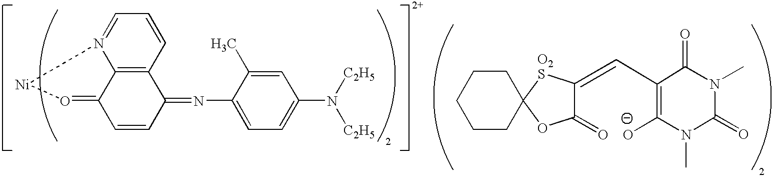

As shown in the Table 1, compared with Comparative Examples in which a system in which a conventional discoloration inhibitor was made to be a counter salt or a mixed system was used, the reproduction after 12 hours of irradiation after the recording was possible in any one of the metal complex compounds of the invention, and the light resistance was improved remarkably. When a metal complex compound was used having a metal complex with a large molar absorbance coefficient in the wavelength range of 350 nm to 1300 nm, represented by the nickel complex (a) of Comparative Example 2 and the metal complex of the cationic part of Comparative Compound (B) in Comparative Example 3, although recording pits could be read, the C/N after the recording did not reach 25 dB, the reproduced signal intensity was insufficient, and the recording characteristics were poor.

From the testing result of durability, there was difficulty in reading pits in the optical information recording media in the Comparative Examples, but in contrast pits could be read in any one of the optical information recording media in the Examples.

### CROSS-REFERENCE TO RELATED APPLICATION

The disclosures of Japanese Patent Application No. 2006-053819 is incorporated herein by reference in its entirety.

1. An optical information recording medium comprising a substrate and a recording layer capable of recording information provided on the substrate, the recording layer comprising a metal complex compound obtained by forming a salt from a cationic part and an anionic part, and the cationic part being a cation of a metal complex having a molar absorbance coefficient (∈) in the wavelength range of 350 to 1300 nm of 10,000 dm³ mol⁻¹ cm⁻¹ or less when an anionic part is any one of Cl⁻, Br⁻, I⁻, Cl₄⁻, PF₆⁻, BF₄⁻, SO₄²⁻, or CF₃SO₃⁻.

2. The optical information recording medium of claim 1, wherein a thermal decomposition temperature of the metal complex is 250° C. or higher when an anionic part of any one of Cl⁻, Br⁻, I⁻, ClO₄⁻, PF₆⁻, BF₄⁻, SO₄²⁻, or CF₃SO₃⁻.

3. The optical information recording medium of claim 1, wherein the cationic part is represented by one of the following Formulae (1) or (2): 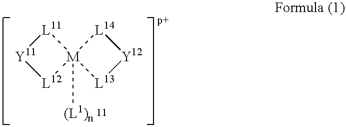
wherein in Formula (1): M represents a metal atom; each of Y¹¹ and Y¹² independently represents a linking group, a single bond, or a double bond; each of L¹, L¹¹, L¹², L¹³, and L¹⁴ independently represents a ligand, and L¹¹ to L¹⁴ may be linked to each other through a linking group which is other than Y¹¹ and Y¹²; n¹¹ represents an integer of 0 to 2; and p represents an integer of 1 to 3: 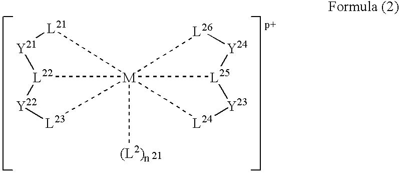
wherein in Formula (2): M represents a metal atom; each of Y²¹, Y²², Y²³, and Y²⁴ independently represents a linking group, a single bond, or a double bond; each of L², L²¹, L²², L²³, L²⁴, L²⁵, and L²⁶ independently represents a ligand, and L²¹ to L²⁶ may be linked to each other through a linking group which is other than Y²¹ to Y²⁴; n²¹ represents an integer of 0 to 2; and p represents an integer of 1 to 3.

4. The optical information recording medium of claim 1, wherein the cationic part is represented by one of the following Formulae (3) or (4): 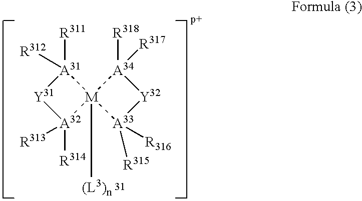
wherein in Formula (3): M represents a metal atom; each of A³¹, A³², A³³, and A³⁴ independently represents a nitrogen atom or a phosphorus atom; each of Y³¹ and Y³² independently represents a linking group; each of R³¹¹, R³¹², R³¹³, R³¹⁴, R³¹⁵, R³¹⁶, R³¹⁷, and R³¹⁸ independently represents a hydrogen atom or a substituent, and R³¹¹ to R³¹⁸ may be linked to each other through a linking group which is other than Y³¹ and Y³²; L³ represents a ligand; n³¹ represents an integer of 0 to 2; and p represents an integer of 1 to 3: 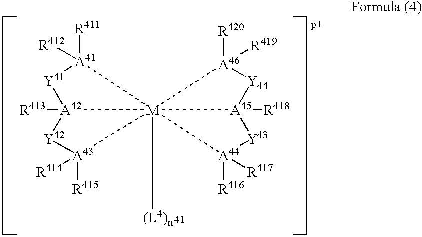
wherein in Formula (4): M represents a metal atom; each of A⁴¹, A⁴², A⁴³, A⁴⁴, A⁴⁵, and A⁴⁶ independently represents a nitrogen atom or a phosphorus atom; each of Y⁴¹, Y⁴², Y⁴³, and Y⁴⁴ independently represents a linking group; each of R⁴¹¹, R⁴¹², R⁴¹³, R⁴¹⁴, R⁴¹⁵, R⁴¹⁶, R⁴¹⁷, R⁴¹⁸, R⁴¹⁹, and R⁴²⁰ independently represents a hydrogen atom or a substituent, and R⁴¹¹ to R⁴²⁰ may be linked to each other through a linking group which is other than Y⁴¹ to Y⁴⁴; L⁴ represents a ligand; n⁴¹ represents an integer of 0 to 2; and p represents an integer of 1 to 3.

5. The optical information recording medium of claim 4, wherein the cationic part is represented by Formula (3), each of the linking groups represented by Y³¹ or Y³² is an alkylene group or an arylene group.

6. The optical information recording medium of claim 5, wherein each of A³¹-Y³¹-A³² and A³⁴-Y³²-A³³ is independently an alkylene diamine, a cyclam, a cyclene, or a phenylenediamine.

7. The optical information recording medium of claim 4, wherein the cationic part is represented by Formula (4), each of the linking groups represented by Y⁴¹, Y⁴², Y⁴³, and Y⁴⁴ is an alkylene group or an arylene group.

8. The optical information recording medium of claim 7, wherein each of A⁴¹-Y⁴¹-A⁴², A⁴²-Y⁴²-A⁴³, A⁴⁶-Y⁴⁴-A⁴⁵, and A⁴⁵-Y⁴³-A⁴⁴ is independently an alkylene diamine, a cyclam, a cyclene, or a phenylenediamine.

9. The optical information recording medium of claim 1, wherein a metal atom in the metal complex is selected from the group consisting of Zn, Cu, Ni, Co, Fe and Mn.

10. The optical information recording medium of claim 1, wherein the recording layer can perform recording by irradiation with a blue laser beam having a wavelength of 440 nm or less.

11. The optical information recording medium of claim 1, wherein the recording layer further comprises an oxonol dye represented by the following Formula (5) or an oxonol dye which is a multimer in which two or more molecules, each of which is represented by Formula (5) and may be similar to or different from each other, are linked to each other through any of A, B, C, and D in Formula (5): 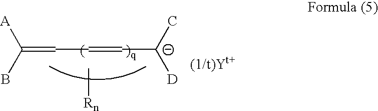
wherein in Formula (5): each of A, B, C, and D independently represents an electron attractive group, A and B or C and D may be linked to each other to form a ring, and the sum of Hammet values (σₚ) of A and B and the sum of Hammet values (σₚ) of C and D are both 0.6 or more when A and B or C and D is not linked to each other; R represents a substituent on a methine carbon; q represents an integer of 0 or 1; n represents an integer of 0 to 2q+1; a plurality of Rs may be the same with or may be different from each other and may form a ring by linking to each other when n is an integer of 2 or more; Y^{t+} represents a t-valent cation; and t represents an integer of 1 to 10.

12. The optical information recording medium of claim 1, wherein the anionic part of the metal complex compound is an anion derived from an oxonol dye represented by the following Formula (5a) or an anion derived from an oxonol dye which is a multimer in which two or more molecules, each of which is represented by Formula (5a) and may be similar to or different from each other, are linked to each other through any of A, B, C, and D in Formula (5a): 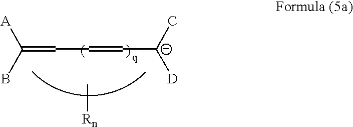
wherein in Formula (5a): each of A, B, C, and D independently represents an electron attractive group, A and B or C and D may be linked to each other to form a ring, and the sum of Hammet values (σₚ) of A and B and the sum of Hammet values (σₚ) of C and D are both 0.6 or more when A and B or C and D is not linked to each other; R represents a substituent on a carbon in methine; q represents an integer of 0 or 1; n represents an integer of 0 to 2q+1; and a plurality of Rs may be the same with or may be different from each other and may form a ring by linking to each other when n is an integer of 2 or more.

13. The optical information recording medium of claim 1, which further comprises a light reflection layer comprising a metal.

14. The optical information recording medium of claim 1, which further comprises a protective layer.

15. The optical information recording medium of claim 1, wherein the substrate is a transparent disk-shaped substrate having a pre-groove on one side thereof with a track pitch of 50 to 500 nm, and the recording layer is provided on the side where the pre-groove is formed.

16. A metal complex formed by salt formation from a cationic part and an anionic part, wherein:
the cationic part is represented by one of the following Formulae (1) or (2) and its molar absorbance coefficient (∈) in the wavelength range of 350 to 1300 nm is 10,000 dm³ mol⁻¹ cm⁻¹ or less when an anionic part is any one of Cl⁻, Br⁻, I⁻, ClO₄⁻, PF₆⁻, BF₄⁻, SO₄²⁻, and CF₃SO₃⁻; and
the anionic part of the metal complex compound is an anion derived from an oxonol dye represented by the following Formula (5a) or an anion derived from an oxonol dye which is a multimer in which two or more molecules, each of which is represented by Formula (5a) and may be similar to or different from each other, are linked to each other through any of A, B, C, and D in Formula (5a): 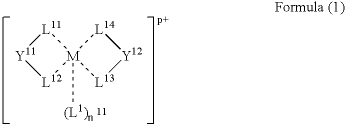
wherein in Formula (1): M represents a metal atom; each of Y¹¹ and Y¹² independently represents a linking group, a single bond, or a double bond; each of L¹, L¹¹, L¹², L¹³, and L¹⁴ independently represents a ligand, and L¹¹ to L¹⁴ may be linked to each other through a linking group which is other than Y¹¹ and Y¹²; n¹¹ represents an integer of 0 to 2; and p represents an integer of 1 to 3: 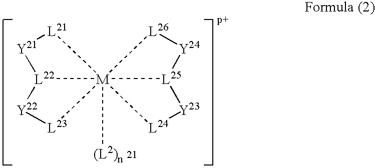
wherein in Formula (2): M represents a metal atom; each of Y²¹, Y²², Y²³, and Y²⁴ independently represents a linking group, a single bond, or a double bond; each of L², L²¹, L²², L²³, L²⁴, L²⁵, and L²⁶ independently represents a ligand, and L²¹ to L²⁶ may be linked to each other through a linking group which is other than Y²¹ to Y²⁴; n²¹ represents an integer of 0 to 2; and p represents an integer of 1 to 3: 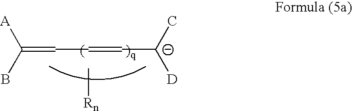
wherein in Formula (5a): each of A, B, C, and D independently represents an electron attractive group, A and B or C and D may be linked to each other to form a ring, and the sum of Hammet values (σₚ) of A and B and the sum of Hammet values (σₚ) of C and D are both 0.6 or more when A and B or C and D is not linked to each other; R represents a substituent on a carbon in methine; q represents an integer of 0 or 1; n represents an integer of 0 to 2q+1; and a plurality of Rs may be the same with or may be different from each other and may form a ring by linking to each other when n is an integer of 2 or more.

17. The metal complex of claim 16, wherein the cationic part is represented by one of the following Formulae (3) or (4): 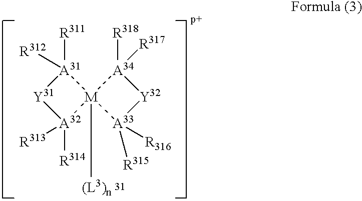
wherein in Formula (3): M represents a metal atom; each of A³¹, A³², A³³, and A³⁴ independently represents a nitrogen atom or a phosphorus atom; each of Y³¹ and Y³² independently represents a linking group; each of R³¹¹, R³¹², R³¹³, R³¹⁴, R³¹⁵, R³¹⁶, R³¹⁷, and R³¹⁸ independently represents a hydrogen atom or a substituent, and R³¹¹ to R³¹⁸ may be linked to each other through a linking group which is other than Y³¹ and Y³²; L³ represents a ligand; n³¹ represents an integer of 0 to 2; and p represents an integer of 1 to 3: 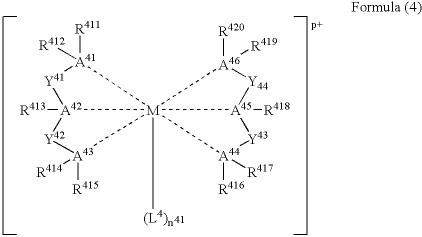
wherein in Formula (4): M represents a metal atom; each of A⁴¹, A⁴², A⁴³, A⁴⁴, A⁴⁵, and A⁴⁶ independently represents a nitrogen atom or a phosphorus atom; each of Y⁴¹, Y⁴², Y⁴³, and Y⁴⁴ independently represents a linking group; each of R⁴¹¹, R⁴¹², R⁴¹³, R⁴¹⁴, R⁴¹⁵, R⁴¹⁶, R⁴¹⁷, R⁴¹⁸, R⁴¹⁹, and R⁴²⁰ independently represents a hydrogen atom or a substituent, and R⁴¹¹ to R⁴²⁰ may be linked to each other through a linking group which is other than Y⁴¹ to Y⁴⁴; L⁴ represents a ligand; n⁴¹ represents an integer of 0 to 2; and p represents an integer of 1 to 3.

18. The metal complex of claim 16, wherein a metal atom therein is selected from the group consisting of Zn, Cu, Ni, Co, Fe and Mn.
